(19) United States
(12) Patent Application Publication
(10) Pub. No.: US 2024/0300856 A1
(43) Pub. Date: Sep. 12, 2024

(54) NON-FRANGIBLE STRESS PROFILES WITH HIGH STRESS AREA FOR IMPROVED FRACTURE RESISTANCE

(71) Applicant: CORNING INCORPORATED, CORNING, NY (US)

(72) Inventor: Rostislav Vatchev Roussev, Painted Post, NY (US)

(73) Assignee: CORNING INCORPORATED, CORNING, NY (US)

(21) Appl. No.: 18/597,530

(22) Filed: Mar. 6, 2024

Related U.S. Application Data
(60) Provisional application No. 63/450,276, filed on Mar. 6, 2023.

(51) Int. Cl. C03C 21/00; C03C 3/091; C03C 4/18

(52) U.S. Cl. CPC C03C 21/002; C03C 3/091; C03C 4/18; C03C 2204/00

(57) ABSTRACT

In one or more embodiments, a chemically strengthened glass-based article comprises a first major surface and an opposing second major surface defining a thickness t of the glass article, a stress profile σ(x) that extends through a thickness t of the glass article, a first compressive stress layer extending to a first depth DOC₁ greater than about 0.15 t, a second compressive stress layer extending from the second major surface to a second depth of compression DOC₂ less than or equal to DOC₁, and a central tension zone positioned between the first and second compressive stress layers and comprising a peak tension PT and a breadth of tension zone BTZ spanning DOC₁ to t-DOC₂. In embodiments, the following criteria are met:

$$\frac{DOC}{t} {s}_{σ}^{DOC} > 0.2 MPa / μm ,$$

where DOC=DOC₁ and s_{σ}^{DOC} is the slope of the stress profile σ(x) at DOC;

$$DOC \times {s}_{σ}^{DOC} > 140 MPa ; and \frac{TA}{PT \times BTZ} > 0.735 ,$$

where TA is the tension area, defined by:

$$TA = {\int }_{{DOC}_{1}}^{t - {DOC}_{2}} σ ( x ) dx .$$

### CROSS REFERENCE TO RELATED APPLICATIONS

This application claims the benefit of U.S. Provisional Patent Application Ser.

No. 63/450,276 entitled “Non-Frangible Stress Profiles With High Stress Area For Improved Fracture Resistance,” filed Mar. 6, 2023, the entire contents of which are incorporated herein by reference.

### TECHNICAL FIELD

The present specification generally relates to chemically strengthened glass-based articles and, more specifically, to non-frangible chemically strengthened glass-based articles.

### BACKGROUND

Chemically strengthened glass is widely used as cover glass for mobile devices, touch-enabled displays, and the like. In general, non-frangible ion-exchanged glass is preferred as a cover glass for touch-screen devices in order to reduce the risk of user injury from small glass particles that may be ejected during the self-accelerating highly fragmented fracture that is characteristic of highly-frangible stress conditions. Such conditions are often produced as a result of combinations of excessive compressive stress in the surface layers of the glass-based article and balancing excessive tensile stress in the central tension zone of the glass-based article. There is an on-going need for glass-based articles having desirable stress profiles imparted via strengthening that provide the glass with good mechanical and fracture properties for use in a variety of applications, including cover glass applications.

### SUMMARY

Many electronic devices, for example smart phones, tablets, portable media players, personal computers, and cameras, incorporate cover glasses that may function as display covers, and may incorporate touch functionality. Cover glasses for electronic devices are provided with significantly enhanced fracture resistance via strengthening processes, e.g., an ion-exchange process. Such strengthening processes provide the cover glass with compressive stress layers extending from the exterior surfaces to a limited depth of compression (DOC). The compressive stress in the compressive stress layers is balanced by a central tension zone positioned between the compressive stress layers.

There are two major failure modes of cover glass when the associated portable device is dropped on a hard surface. One of the modes is flexure failure, which is caused by bending of the glass when the device is subjected to dynamic load from impact with the hard surface. The other mode is sharp contact failure, which is caused by introduction of damage to the glass surface. Impact of the glass with rough hard surfaces, such as asphalt, granite, etc., can result in sharp indentations in the glass surface. These indentations become failure sites in the glass surface from which cracks may develop and propagate.

In general, the deeper the DOC and the greater the compressive stress in the compressive layer, the better the cover glass will be able to withstand drops on hard surfaces, especially rough surfaces, as flaws thereby introduced into the surface of the cover glass will be less likely to penetrate through the compressive stress layer and into the central tension zone where they can propagate cracks that negatively affect the use of the device. However, given that surface flaws may, in some circumstances, penetrate through the compressive stress layers, it is preferred that the cover glass be non-frangible in order to, among other reasons, reduce the risk of user injury from small glass particles that may be ejected during the self-accelerating highly fragmented fracture that may occur in highly-frangible stress conditions. Moreover, because the frangibility of the cover glass is in part determined by the magnitude and distribution of tensile stress in the central tension zone, care must be given when designing the compressive stress layers so as to not cause the balancing central tension zone to have a frangible stress profile. Thus, an on-going need exists for chemically strengthened glass-based articles that exhibit both improved fracture resistance and non-frangibility.

One driver for frangibility is the tensile-strain energy (TSE) of the glass-based article. It has been found that in order to produce deep compressive stress layers while at the same time avoiding frangibility, the tension area, i.e., the tensile stress integrated through the thickness of the central tension zone, should be maximized relative to an acceptable level of TSE. The acceptable level of TSE is determined based on the on fracture toughness of the glass-based article, and the actual TSE is proportional to the squared tensile stress integrated through the thickness of the central tension zone. Because the TSE is proportional to the depth integral of the squared tensile stress, where the tension area, i.e., the force balancing the compressive forces in the compression layers, is the depth integral of only the tensile stress (not squared), a more uniform distribution of the tensile stress in the central tension zone will maximize the tension area relative to a given TSE (set according to the acceptable level discussed above).

The present disclosure provides non-frangible, chemically strengthened glass-based articles with improved fracture resistance through the incorporation of compressive stress layers having both high DOC and high stress magnitude deep into the compressive stress layers. The present disclosure is focused on increasing the levels of deep compressive stress for any fixed material parameters (e.g., fracture toughness), such that the performance boost produced associated with the present disclosure can be added to any performance boost based on advancing material properties. Moreover, it should be understood that the concepts disclosed herein regarding non-frangible stress profiles could be implemented in articles of varying thickness, varying number and assemblage of phases (e.g., entirely amorphous glasses or glasses having a precipitated crystalline phase), and varying composition (e.g., Li-free). Finally, while the glass-based articles discussed herein are generally planar, the concepts discussed could also be applied to non-planar articles.

According to a first aspect of the present disclosure, a chemically strengthened glass-based article comprises: a first major surface and an opposing second major surface defining a thickness t of the glass article; a stress profile σ(x) wherein x extends through the thickness t of the glass article in a direction normal to the first major surface and the second major surface; a first compressive stress layer extending from the first major surface to a first depth of compression DOC₁ that is greater than about 0.15 t; a second compressive stress layer extending from the second major surface to a second depth of compression DOC₂ that is less than or equal to DOC₁; and a central tension zone positioned between the first and second compressive stress layers and comprising a peak tension PT and a breadth of tension zone (BTZ) spanning DOC₁ to t-DOC₂, wherein:

$$\frac{DOC}{t} {s}_{σ}^{DOC} > 0.2 MPa / µm ,$$

where DOC=DOC₁ and s_{σ}^{DOC} is the slope of the stress profile σ(x) at DOC; and

$$\frac{TA}{PT \times BTZ} > 0.735 ,$$

where TA is the tension area, defined by:

$$TA = {\int }_{{DOC}_{1}}^{t - {DOC}_{2}} σ ( x ) dx .$$

A second aspect may include the first aspect, wherein DOC×s_{σ}^{DOC} for the chemically strengthened glass-based article is greater than 140 MPa.

A third aspect may include any of the previous aspects, wherein t×s_{σ}^{DOC} for the chemically strengthened glass-based article is greater than 900 MPa.

A fourth aspect may include any of the previous aspects, wherein the peak tension PT for the chemically strengthened glass-based article is greater than 90 MPa.

A fifth aspect may include any of the previous aspects, wherein the peak tension PT for the chemically strengthened glass-based article is greater than

$$2.5 \frac{{K}_{IC}}{\sqrt{t}} ,$$

where K_{IC} is a fracture toughness of the glass article in a position xₚₑₐₖ in the central tension zone corresponding with the peak tension PT.

A sixth aspect may include any of the previous aspects, wherein the thickness t of the chemically strengthened glass-based article is between 0.4 mm and 0.77 mm.

A seventh aspect may include any of the previous aspects, wherein a composition of the chemically strengthened glass-based article comprises less than 3 mol % Li₂O and a fracture toughness K_{IC} of the glass article is greater than or equal to 0.720 MPa\sqrt{m} in a position xₚₑₐₖ in the central tension zone corresponding with the peak tension PT.

A eighth aspect may include any of the first through sixth aspects, wherein a composition of the chemically strengthened glass-based article comprises Li₂O in an amount in the range from about 3.0 mol % to about 7.5 mol % and a fracture toughness K_{IC} of the glass article is greater than or equal to 0.810 MPa\sqrt{m} in a position xₚₑₐₖ in the central tension zone corresponding with the peak tension PT.

A ninth aspect may include any of the first through fifth aspects, wherein a composition of the chemically strengthened glass-based article comprises Li₂O in an amount in the range from about 7.5 mol % to about 11 mol % and a fracture toughness K_{IC} of the glass article is greater than or equal to 0.850 MPa\sqrt{m} in a position xₚₑₐₖ in the central tension zone corresponding with the peak tension PT.

A tenth aspect may include any of the first through fifth aspects, wherein a composition of the chemically strengthened glass-based article comprises Li₂O in an amount in the range from about 11 mol % to about 13 mol % and a fracture toughness K_{IC} of the glass article is greater than or equal to 0.870 MPa\sqrt{m} in a position xₚₑₐₖ in the central tension zone corresponding with the peak tension PT.

An eleventh aspect may include any of the first through fifth aspects, wherein a composition of the chemically strengthened glass-based article comprises greater than about 13 mol % Li₂O; and a fracture toughness K_{IC} of the glass article is greater than or equal to 0.950 MPa\sqrt{m} in a position xₚₑₐₖ in the central tension zone corresponding with the peak tension PT.

A twelfth aspect may include any of the previous aspects, wherein the stress profile σ(x) in the central tension zone, when fit to Equation I,

$$σ ( x ) = PT [ 1 - {\vert \frac{{x}_{peak} - x}{{x}_{peak} - DOC} \vert}^{p} ] , \qquad ( Equation I )$$

has a best-fit value of power coefficient p that exceeds 2.75, wherein xₚₑₐₖ is a position in the central tension zone corresponding with the peak tension PT.

A thirteenth aspect may include any of the previous aspects, wherein the power coefficient p does not exceed 20.

A fourteenth aspect may include any of the previous aspects, wherein the chemically strengthened glass-based article comprise a frangibility factor Kₜ not exceeding 2.1×K_{IC}, wherein K_{IC} is a fracture toughness of the glass article in a position xₚₑₐₖ in the central tension zone corresponding with the peak tension PT, and wherein:

$${K}_{t} = \sqrt{{\int }_{{DOC}_{1}}^{t - {DOC}_{2}} {σ}^{2} dx} ,$$

where a is the stress profile σ(x).

A fifteenth aspect may include any of the previous aspects, wherein Kₜ≤1.97×K_{IC}.

A sixteenth aspect may include any of the previous aspects, wherein DOC is greater than or equal to 0.190 t.

A seventeenth aspect may include any of the previous aspects, wherein the chemically strengthened glass-based article comprises a surface compressive stress CS at each of the first and second major surfaces satisfies Relation I:

$$100 MPa \leq CS \leq 1.1 DOC \times {s}_{σ}^{DOC} . \qquad ( Relation I )$$

A eighteenth aspect may include any of the previous aspects, wherein the stress profile σ(x) of the chemically strengthened glass-based article exhibits a spike at the first and second major surfaces and a knee stress CSₖ at a depth of spike DOL_{SP} satisfies Relation II:

$$100 MPa \leq {CS}_{k} \leq 1.1 ( DOC - {DOL}_{sp} ) \times {s}_{σ}^{DOC} . \qquad ( Relation II )$$

A nineteenth aspect may include any of the previous aspects, wherein the following criterion is met for the chemically strengthened glass-based article:

$$0 \leq {DOL}_{sp} \leq {DOL}_{ul} ,$$

where DOLᵤₗ is the larger of 4 μm and 0.01 t.

A twentieth aspect may include any of the previous aspects, wherein the stress profile σ(x) of the chemically strengthened glass-based article exhibits a spike at the first and second major surfaces and a knee stress CSₖ at a depth of spike DOL_{SP}, wherein a portion of the stress profile σ(x) between DOL_{SP} and DOC comprises a negative second derivative.

According to a first aspect of the present disclosure, a chemically strengthened glass-based article comprises: a first major surface and an opposing second major surface defining a thickness t of the glass article; a stress profile σ(x) wherein x extends through the thickness t of the glass article in a direction normal to the first major surface and the second major surface; a first compressive stress layer extending from the first major surface to a first depth of compression DOC₁ that is greater than about 0.15 t; a second compressive stress layer extending from the second major surface to a second depth of compression DOC₂ that is less than or equal to DOC₁; and a central tension zone positioned between the first and second compressive stress layers and comprising a peak tension PT and a breadth of tension zone (BTZ) spanning DOC₁ to t-DOC₂, wherein:

$$\frac{DOC}{t} {s}_{σ}^{DOC} > 0.2 MPa / µm ,$$

where DOC=DOC₁ and s_{σ}^{DOC} is the slope of the stress profile σ(x) at DOC; and

$$\frac{TA}{PT \times BTZ} > 0.735 ,$$

where TA is the tension area, defined by:

$$TA = {\int }_{{DOC}_{1}}^{t - {DOC}_{2}} σ ( x ) dx .$$

A second aspect may include the first aspect, wherein DOC×s_{σ}^{DOC} for the chemically strengthened glass-based article is greater than 140 MPa.

A third aspect may include any one of the previous aspects, wherein t×s_{σ}^{DOC} for the chemically strengthened glass-based article is greater than 900 MPa.

A fourth aspect may include any one of the previous aspects, wherein the peak tension PT for the chemically strengthened glass-based article is greater than 90 MPa.

A fifth aspect may include any one of the previous aspects, wherein the peak tension PT for the chemically strengthened glass-based article is greater than

$$2.5 \frac{{K}_{IC}}{\sqrt{t}} ,$$

where K_{IC} is a fracture toughness of the glass article in a position xₚₑₐₖ in the central tension zone corresponding with the peak tension PT.

A sixth aspect may include any one of the previous aspects, wherein the thickness t of the chemically strengthened glass-based article is between 0.4 mm and 0.77 mm.

A seventh aspect may include any one of the previous aspects, wherein a composition of the chemically strengthened glass-based article comprises less than 3 mol % Li₂O and a fracture toughness K_{IC} of the glass article is greater than or equal to 0.720 MPa\sqrt{m} in a position xₚₑₐₖ in the central tension zone corresponding with the peak tension PT.

An eighth aspect may include any one of the first through sixth aspects, wherein a composition of the chemically strengthened glass-based article comprises Li₂O in an amount in the range from about 3.0 mol % to about 7.5 mol % and a fracture toughness K_{IC} of the glass article is greater than or equal to 0.810 MPa\sqrt{m} in a position xₚₑₐₖ in the central tension zone corresponding with the peak tension PT.

A ninth aspect may include any one of the first through sixth aspects, wherein a composition of the chemically strengthened glass-based article comprises Li₂O in an amount in the range from about 7.5 mol % to about 11 mol % and a fracture toughness K_{IC} of the glass article is greater than or equal to 0.850 MPa\sqrt{m} in a position xₚₑₐₖ in the central tension zone corresponding with the peak tension PT.

A tenth aspect may include any one of the first through sixth aspects, wherein a composition of the chemically strengthened glass-based article comprises Li₂O in an amount in the range from about 11 mol % to about 13 mol % and a fracture toughness K_{IC} of the glass article is greater than or equal to 0.870 MPa\sqrt{m} in a position xₚₑₐₖ in the central tension zone corresponding with the peak tension PT.

An eleventh aspect may include one any of the first through sixth aspects, wherein a composition of the chemically strengthened glass-based article comprises greater than about 13 mol % Li₂O; and a fracture toughness K_{IC} of the glass article is greater than or equal to 0.950 MPa\sqrt{m} in a position xₚₑₐₖ in the central tension zone corresponding with the peak tension PT.

A twelfth aspect may include any one of the previous aspects, wherein the stress profile σ(x) in the central tension zone, when fit to Equation I,

$$σ ( x ) = PT [ 1 - {\vert \frac{{x}_{peak} - x}{{x}_{peak} - DOC} \vert}^{p} ] , \qquad ( Equation I )$$

has a best-fit value of power coefficient p that exceeds 2.75, wherein xₚₑₐₖ is a position in the central tension zone corresponding with the peak tension PT.

A thirteenth aspect may include any one of the previous aspects, wherein the power coefficient p does not exceed 20.

A fourteenth aspect may include any one of the previous aspects, wherein the chemically strengthened glass-based article comprise a frangibility factor Kₜ not exceeding 2.1×K_{IC}, wherein K_{IC} is a fracture toughness of the glass article in a position xₚₑₐₖ in the central tension zone corresponding with the peak tension PT, and wherein:

$${K}_{t} = \sqrt{{\int }_{{DOC}_{1}}^{t - {DOC}_{2}} {σ}^{2} dx} ,$$

where σ is the stress profile σ(x).

A fifteenth aspect may include any one of the previous aspects, wherein Kₜ≤1.97×K_{IC}.

A sixteenth aspect may include any one of the previous aspects, wherein DOC is greater than or equal to 0.190 t.

A seventeenth aspect may include any one of the previous aspects, wherein the chemically strengthened glass-based article comprises a surface compressive stress CS at each of the first and second major surfaces satisfies Relation I:

$$100 MPa \leq CS \leq 1.1 DOC \times {s}_{σ}^{DOC} . \qquad ( Relation I )$$

An eighteenth aspect may include any one of the previous aspects, wherein the stress profile σ(x) of the chemically strengthened glass-based article exhibits a spike at the first and second major surfaces and a knee stress CSₖ at a depth of spike DOL_{SP} satisfies Relation II:

$$100 MPa \leq {CS}_{k} \leq 1.1 ( DOC - {DOL}_{sp} ) \times {s}_{σ}^{DOC} . \qquad ( Relation II )$$

A nineteenth aspect may include any one of the previous aspects, wherein the following criterion is met for the chemically strengthened glass-based article:

$$0 \leq {DOL}_{sp} \leq {DOC}_{ul} ,$$

where DOLᵤₗ is the larger of 4 μm and 0.01 t.

A twentieth aspect may include any one of the previous aspects, wherein the stress profile σ(x) of the chemically strengthened glass-based article exhibits a spike at the first and second major surfaces and a knee stress CSₖ at a depth of spike DOL_{SP}, wherein a portion of the stress profile σ(x) between DOL_{SP} and DOC comprises a negative second derivative.

According to a twenty-first aspect of the present disclosure, a chemically strengthened glass-based article comprises: a first major surface and an opposing second major surface defining a thickness t of the glass article; a stress profile σ(x) wherein x extends through the thickness t of the glass article in a direction normal to the first major surface and the second major surface; a first compressive stress layer extending from the first major surface to a first depth of compression DOC₁ that is greater than about 0.15 t; a second compressive stress layer extending from the second major surface to a second depth of compression DOC₂ that is less than or equal to DOC₁; and a central tension zone positioned between the first and second compressive stress layers and comprising a peak tension PT and a breadth of tension zone (BTZ) spanning DOC₁ to t-DOC₂, wherein:

$$\frac{DOC}{t} {S}_{σ}^{DOC} > 0.2 MPa / μm ,$$

where DOC=DOC₁ and s_{σ}^{DOC} is the slope of the stress profile σ(x) at DOC; and

$$DOC \times {s}_{σ}^{DOC} > 140 MPa ; and \frac{TA}{PT \times BTZ} > 0.735 ,$$

where TA is the tension area, defined by:

$$TA = {\int }_{{DOC}_{1}}^{t - {DOC}_{2}} σ ( x ) dx .$$

A twenty-second aspect may include the twenty-first aspect, wherein the peak tension PT is greater than 90 MPa.

A twenty-third aspect may include the twenty-first aspect, wherein the peak tension PT is greater than 115 MPa.

A twenty-fourth aspect may include the twenty-first aspect, wherein the peak tension PT is greater than 125 MPa.

A twenty-fifth aspect may include any one of the twenty-first through twenty-fourth aspects, wherein:

$$PT > 2.5 \frac{{K}_{IC}}{\sqrt{t}} ,$$

where K_{IC} is a fracture toughness of the glass-based article in a position xₚₑₐₖ in the central tension zone corresponding with the peak tension PT.

A twenty-sixth aspect may include the twenty-fifth aspect, wherein

$$PT > 2.9 \frac{{K}_{IC}}{\sqrt{t}} .$$

A twenty-seventh aspect may include twenty-fifth aspect, wherein

$$PT > 3.25 \frac{{K}_{IC}}{\sqrt{t}} .$$

A twenty-eighth aspect may include any one of the twenty-first through twenty-seventh aspects, wherein the thickness t of the glass-based article is between 0.4 mm and 0.77 mm.

A twenty-ninth aspect may include any one of the twenty-first through twenty-seventh aspects, wherein the thickness t of the glass-based article is between 0.43 mm and 0.68 mm.

A thirtieth aspect may include any one of the twenty-first through twenty-ninth aspects, wherein a composition of the glass-based article comprises less than 3 mol % Li₂O, and wherein a fracture toughness K_{IC} of the glass-based article is greater than or equal to 0.720 MPa\sqrt{m} in a position xₚₑₐₖ in the central tension zone corresponding with the peak tension PT.

A thirty-first aspect may include any one of the twenty-first through twenty-ninth aspects, wherein a composition of the glass-based article comprises Li₂O in an amount in the range from about 3.0 mol % to about 7.5 mol %, and wherein a fracture toughness K_{IC} of the glass-based article is greater than or equal to 0.810 MPa\sqrt{m} in a position xₚₑₐₖ in the central tension zone corresponding with the peak tension PT.

A thirty-second aspect may include any one of the twenty-first through twenty-ninth aspects, wherein a composition of the glass-based article comprises Li₂O in an amount in the range from about 7.5 mol % to about 11 mol %, and wherein a fracture toughness K_{IC} of the glass-based article is greater than or equal to 0.850 MPa\sqrt{m} in a position xₚₑₐₖ in the central tension zone corresponding with the peak tension PT.

A thirty-third aspect may include any one of the twenty-first through twenty-ninth aspects, wherein a composition of the glass-based article comprises Li₂O in an amount in the range from about 11 mol % to about 13 mol %, and wherein a fracture toughness K_{IC} of the glass-based article is greater than or equal to 0.870 MPa\sqrt{m} in a position xₚₑₐₖ in the central tension zone corresponding with the peak tension PT.

A thirty-fourth aspect may include any one of the twenty-first through twenty-ninth aspects, wherein a composition of the glass-based article comprises greater than about 13 mol % Li₂O, and wherein a fracture toughness K_{IC} of the glass-based article is greater than or equal to 0.950 MPa\sqrt{m} in a position xₚₑₐₖ in the central tension zone corresponding with the peak tension PT.

A thirty-fifth aspect may include any one of the twenty-first through thirty-fourth aspects, wherein the stress profile σ(x) in the central tension zone, when fit to Equation I,

$$σ ( x ) = PT [ 1 - {\vert \frac{{x}_{peak} - x}{{x}_{peak} - DOC} \vert}^{p} ] , \qquad ( Equation I )$$

has a best-fit value of power coefficient p that exceeds 2.4, wherein xₚₑₐₖ is a position in the central tension zone corresponding with the peak tension PT.

A thirty-sixth aspect may include the thirty-fifth aspect, wherein the best-fit value of power coefficient p exceeds 2.75.

A thirty-seventh aspect may include the thirty-fifth aspect, wherein the best-fit value of power coefficient p exceeds 3.2.

A thirty-eighth aspect may include any one of the thirty-fifth through thirty-seventh aspects, wherein power coefficient p does not exceed 20.

A thirty-ninth aspect may include any one of the twenty-first through thirty-eighth aspects, further comprising a frangibility factor Kₜ not exceeding 2.1×K_{IC}, wherein K_{IC} is a fracture toughness of the glass-based article in a position xₚₑₐₖ in the central tension zone corresponding with the peak tension PT, and wherein:

$${K}_{t} = \sqrt{{\int }_{{DOC}_{1}}^{t - {DOC}_{2}} {σ}^{2} dx} ,$$

where σ is the stress profile σ(x).

A fortieth aspect may include the thirty-ninth aspect wherein Kₜ≤1.97×K_{IC}.

A forty-first aspect may include any one of the twenty-first through fortieth aspects, wherein DOC is greater than or equal to 0.190 t.

A forty-second aspect may include any one of the twenty-first through fortieth aspects, wherein DOC is greater than or equal to 0.200 t.

A forty-third aspect may include any one of the twenty-first through fortieth aspects, wherein DOC is greater than or equal to 0.210 t.

A forty-fourth aspect may include any one of the twenty-first through forty-third aspects, wherein a surface compressive stress CS at each of the first and second major surfaces is greater than 110 MPa.

A forty-fifth aspect may include any one of the twenty-first through forty-fourth aspects, wherein the stress profile σ(x) exhibits a spike at the first and second major surfaces and a knee stress CSₖ at a depth of spike DOL_{SP} satisfies Relation II:

$$100 MPa \leq {CS}_{k} \leq 1.1 ( DOC - {DOL}_{sp} ) \times {s}_{σ}^{DOC} . \qquad ( Relation II )$$

A forty-sixth aspect may include the forty-fifth aspect, wherein the knee stress CSₖ at the depth of spike DOL_{SP} is less than or equal to 1.0(DOC−DOL_{SP})×s_{σ}^{DOC}.

A forty-seventh aspect may include the forty-fifth aspect, wherein the knee stress CSₖ at the depth of spike DOL_{SP} is less than or equal to 0.9(DOC−DOL_{SP})×s_{σ}^{DOC}.

A forty-eighth aspect may include any one of the forty-fifth through forty-seventh aspects, wherein:

$$0 \leq {DOL}_{sp} \leq {DOC}_{ul} ,$$

where DOLᵤₗ is the larger of 4 μm and 0.01 t.

A forty-ninth aspect may include any one of the twenty-first through forty-eighth aspects, wherein the stress profile σ(x) exhibits a spike at the first and second major surfaces and a knee stress CSₖ at a depth of spike DOL_{SP}, and wherein a portion of the stress profile σ(x) between DOL_{SP} and DOC comprises a negative second derivative.

A fiftieth aspect may include any one of the twenty-first through forty-ninth aspects, wherein DOC×s_{σ}^{DOC}>190 MPa.

A fifty-first aspect may include any one of the twenty-first through forty-ninth aspects, wherein DOC×s_{σ}^{DOC}>230 MPa.

A fifty-second aspect may include any one of the twenty-first through forty-ninth aspects, wherein DOC×s_{σ}^{DOC}>265 MPa.

A fifty-third aspect may include any one of the twenty-first through fifty-second aspects, wherein

$$\frac{DOC}{t} {S}_{σ}^{DOC} > 0.3 MPa / μm .$$

A fifty-fourth aspect may include any one of the twenty-first through fifty-second aspects, wherein

$$\frac{DOC}{t} {s}_{σ}^{DOC} > 0.375 MPa / μm .$$

A fifty-fifth aspect may include any one of the twenty-first through fifty-second aspects, wherein

$$\frac{DOC}{t} {s}_{σ}^{DOC} > 0.45 MPa / μm .$$

A fifty-sixth aspect may include any one of the twenty-first through fifty-fifth aspects, wherein t×s_{σ}^{DOC}>700 MPa.

A fifty-seventh aspect may include any one of the twenty-first through fifty-fifth aspects, wherein t×s_{σ}^{DOC}>900 MPa.

A fifty-eighth aspect may include any one of the twenty-first through fifty-fifth aspects, wherein t×s_{σ}^{DOC}>1100 MPa.

A fifty-ninth aspect may include any one of the twenty-first through fifty-eighth aspects, wherein a surface compressive stress CS at each of the first and second major surfaces is greater than 550 MPa.

A sixtieth aspect may include any one of the twenty-first through fifty-eighth aspects, wherein a surface compressive stress CS at each of the first and second major surfaces is greater than 725 MPa.

A sixty-first aspect may include any one of the twenty-first through sixtieth aspects, wherein the chemically strengthened glass-based article comprises an amorphous microstructure substantially free of crystals or crystallites.

A sixty-second aspect may include any one of the twenty-first through sixty-first aspects, wherein the chemically strengthened glass-based article comprises a fracture toughness less than or equal to 1.0 MPa\sqrt{m}.

A sixty-third aspect may include any one of the twenty-first through sixtieth aspects, wherein the chemically strengthened glass-based article is a glass-ceramic material comprising an amorphous phase and a crystalline phase.

A sixty-fourth aspect may include any one of the twenty-first through sixtieth aspects or the sixty-third aspect, wherein the chemically strengthened glass-based article comprises a fracture toughness greater than or equal to 1.2 MPa\sqrt{m}.

A sixty-fifth aspect may include any one of the twenty-first through sixty-fourth aspects, wherein the chemically strengthened glass-based article is formed by subjecting a glass-based substrate to an ion exchange treatment, and wherein the glass-based substrate comprises: greater than or equal to 50 mol % and less than or equal to 75 mol % SiO₂; greater than or equal to 10 mol % and less than or equal to 25 mol % Al₂O₃; greater than or equal to 1 mol % and less than or equal to 11 mol % B₂O₃; greater than or equal to 1 mol % and less than or equal to 10 mol % Na₂O; and greater than or equal to 5 mol % and less than or equal to 15 mol % Li₂O, wherein a molar concentration of Li₂O in the glass-based substrate is greater than a molar concentration of Na₂O in the glass-based substrate.

A sixty-sixth aspect may include any one of the twenty-first through sixty-fifth aspects, wherein the chemically strengthened glass-based article is formed by subjecting a glass-based substrate to an ion exchange treatment, and wherein the glass-based substrate comprises Li₂O in an amount from 7.0 to 15.0 mol %.

A sixty-seventh aspect may include any one of the twenty-first through sixty-sixth aspects, wherein the chemically strengthened glass-based article is formed by subjecting a glass-based substrate to an ion exchange treatment, and wherein the glass-based substrate comprises a molar ratio of Li₂O to Na₂O of greater than or equal to 2.0.

According to a sixty-eighth aspect of the present disclosure, a chemically strengthened glass-based article comprises: a first major surface and an opposing second major surface defining a thickness t of the glass-based article, wherein the thickness t is less than or equal to 0.52 mm; a stress profile σ(x) wherein x extends through the thickness t of the glass-based article in a direction normal to the first major surface and the second major surface; a first compressive stress layer extending from the first major surface to a first depth of compression DOC₁ greater than about 0.15 t; a second compressive stress layer extending from the second major surface to a second depth of compression DOC₂ less than or equal to DOC₁; and a central tension zone positioned between the first and second compressive stress layers and comprising a peak tension PT and a breadth of tension zone BTZ spanning DOC₁ to t-DOC₂, wherein:

$$\frac{DOC}{t} {s}_{σ}^{DOC} > 0.2 MPa / μm ,$$

where DOC=DOC₁ and s_{σ}^{DOC} is the slope of the stress profile σ(x) at DOC;

$$DOC \times {s}_{σ}^{DOC} > 140 MPa ;$$

$$and$$

$$\frac{TA}{PT \times BTZ} > 0.7 ,$$

where TA is the tension area, defined by:

$$TA = {\int }_{{DOC}_{1}}^{t - {DOC}_{2}} σ ( x ) dx .$$

A sixty-ninth aspect may include the sixty-eighth aspect, wherein the peak tension PT is greater than 115 MPa.

A seventieth aspect may include the sixty-eighth aspect, wherein the peak tension PT is greater than 125 MPa.

A seventy-first aspect may include any one of the sixty-eighth through seventieth aspects, wherein the stress profile σ(x) in the central tension zone, when fit to Equation I,

$$σ ( x ) = PT [ 1 - {\vert \frac{{x}_{peak} - x}{{x}_{peak} - DOC} \vert}^{p} ] , \qquad ( Equation I )$$

has a best-fit value of power coefficient p that exceeds 2.4, wherein xₚₑₐₖ is a position in the central tension zone corresponding with the peak tension PT.

A seventy-second aspect may include any one of the sixty-eighth through seventieth aspects, wherein the stress profile σ(x) in the central tension zone, when fit to Equation I,

$$σ ( x ) = PT [ 1 - {\vert \frac{{x}_{peak} - x}{{x}_{peak} - DOC} \vert}^{p} ] , \qquad ( Equation I )$$

has a best-fit value of power coefficient p that exceeds 2.75, wherein xₚₑₐₖ is a position in the central tension zone corresponding with the peak tension PT.

A seventy-third aspect may include any one of the sixty-eighth through seventy-second aspects, wherein the stress profile σ(x) exhibits a spike at the first and second major surfaces and a knee stress CSₖ at a depth of spike DOL_{SP}, and wherein a portion of the stress profile σ(x) between DOL_{SP} and DOC comprises a negative second derivative.

A seventy-fourth aspect may include any one of the sixty-eighth through seventy-third aspects, wherein DOC is greater than or equal to 0.190 t.

A seventy-fifth aspect may include any one of the sixty-eighth through seventy-third aspects, wherein DOC is greater than or equal to 0.200 t.

A seventy-sixth aspect may include any one of the sixty-eighth through seventy-third aspects, wherein DOC is greater than or equal to 0.210 t.

According to a seventy-seventh aspect of the present disclosure, a chemically strengthened glass-based article comprises: a first major surface and an opposing second major surface defining a thickness t of the glass-based article, wherein the thickness t is from about 0.43 mm to about 0.68 mm; a stress profile σ(x) wherein x extends through the thickness t of the glass-based article in a direction normal to the first major surface and the second major surface; a first compressive stress layer extending from the first major surface to a first depth of compression DOC₁ greater than about 0.19 t; a second compressive stress layer extending from the second major surface to a second depth of compression DOC₂ less than or equal to DOC₁; and a central tension zone positioned between the first and second compressive stress layers and comprising a peak tension PT and a breadth of tension zone BTZ spanning DOC₁ to t-DOC₂, wherein: the peak tension PT is greater than 95 MPa; the stress profile σ(x) in the central tension zone, when fit to Equation I,

$$σ ( x ) = PT [ 1 - {\vert \frac{{x}_{peak} - x}{{x}_{peak} - DOC} \vert}^{p} ] , \qquad ( Equation I )$$

has a best-fit value of power coefficient p that exceeds 2.4, where DOC=DOC₁ and xₚₑₐₖ is a position in the central tension zone corresponding with the peak tension PT; and the stress profile σ(x) exhibits a spike at the first and second major surfaces and a knee stress CSₖ at a depth of spike DOL_{SP} satisfies Relation II:

$$100 MPa \leq {CS}_{k} \leq 1.1 ( DOC - {DOL}_{sp} ) \times {s}_{σ}^{DOC} \qquad ( Relation II )$$

where DOC=DOC₁ and s_{σ}^{DOC} is the slope of the stress profile σ(x) at DOC.

A seventy-eighth aspect may include the seventy-seventh aspect, wherein the thickness t is less than or equal to 0.52 mm.

A seventy-ninth aspect may include the seventy-seventh or seventy eighth aspects, wherein the peak tension PT is greater than 103 MPa.

According to an eightieth aspect of the present disclosure, a method of manufacturing a chemically strengthened glass-based article comprises exposing a glass-based substrate to a molten salt bath to form the chemically strengthened glass-based article, wherein: the temperature of the molten salt bath is less than a strain point of the glass-based substrate by no more than 110° C., wherein the strain point of the glass-based substrate is determined by fiber elongation; the chemically strengthened glass-based article comprises a first major surface and an opposing second major surface defining a thickness t of the glass-based article; and the ion exchange treatment time is selected such that the chemically strengthened glass-based article comprises: a stress profile σ(x) wherein x extends through the thickness t of the glass-based article in a direction normal to the first major surface and the second major surface; a first compressive stress layer extending from the first major surface to a first depth of compression DOC₁ greater than about 0.15 t; a second compressive stress layer extending from the second major surface to a second depth of compression DOC₂ less than or equal to DOC₁; and a central tension zone positioned between the first and second compressive stress layers and comprising a peak tension PT and a breadth of tension zone BTZ spanning DOC₁ to t-DOC₂, wherein:

$$\frac{DOC}{t} {s}_{σ}^{DOC} > 0.2 MPa / μm ,$$

where DOC=DOC₁ and s_{σ}^{DOC} is the slope of the stress profile σ(x) at DOC;

$$DOC \times {s}_{σ}^{DOC} > 140 MPa ;$$

$$and$$

$$\frac{TA}{PT \times BTZ} > 0.735 ,$$

where TA is the tension area, defined by:

$$TA = {\int }_{{DOC}_{1}}^{t - {DOC}_{2}} σ ( x ) dx .$$

An eighty-first aspect may include the eightieth aspect, wherein the temperature of the molten salt bath is from 455° C. to 490° C.

An eighty-second aspect may include the eightieth or eighth-first aspects, wherein the ion exchange treatment time is from 2 to 4 hours.

An eighty-third aspect may include any one of the eightieth through eighty-second aspects, wherein the glass-based substrate comprises: greater than or equal to 50 mol % and less than or equal to 75 mol % SiO₂; greater than or equal to 10 mol % and less than or equal to 25 mol % Al₂O₃; greater than or equal to 1 mol % and less than or equal to 11 mol % B₂O₃; greater than or equal to 1 mol % and less than or equal to 10 mol % Na₂O; and greater than or equal to 5 mol % and less than or equal to 15 mol % Li₂O, wherein a molar concentration of Li₂O in the glass-based substrate is greater than a molar concentration of Na₂O in the glass-based substrate.

An eighty-fourth aspect may include any one of the eightieth through eighty-third aspects, wherein the glass-based substrate comprises Li₂O in an amount from 7.0 to 15.0 mol %.

An eighty-fifth aspect may include any one of the eightieth through eighty-fourth aspects, wherein the glass-based substrate comprises a molar ratio of Li₂O to Na₂O of greater than or equal to 2.0.

Additional features and advantages of the chemically strengthened glass-based articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic cross-sectional view of a chemically strengthened glass-based article;

FIG. 2a schematically depicts strengthened glass-based articles 1) exhibiting frangible behavior upon fragmentation; and 2) exhibiting non-frangible behavior upon fragmentation;

FIG. 2b schematically depicts strengthened glass-based articles exhibiting non-frangible behavior upon fragmentation;

FIG. 3 is a plot showing stress profiles for glass-based articles approximated as power profiles with different power coefficients p, where tension (y-axis) is plotted as a function of depth (x-axis);

FIG. 4 is a plot showing stress profile attributes

$$\frac{TA}{tPT} and \frac{TA}{BTZ \times PT}$$

(y-axis) in terms of power coefficient p (x-axis);

FIG. 5 is a plot showing stress profile attributes

$$\frac{TA}{{K}_{t} \sqrt{BTZ}}$$

(x-axis) in terms of power coefficient p (x-axis); and

FIG. 6 is a plot showing stress profile attributes

$${s}_{σ}^{DOC} , \frac{{TAs}_{σ}^{DOC}}{tPT} , and \frac{{TAs}_{σ}^{DOC}}{BTZ \times PT}$$

(y axis) in terms of power coefficient p (x-axis);

FIG. 7 is a plot showing averaged retardance in degrees (y-axis) as a function of depth (x-axis) for a chemically strengthened glass-based article of the present disclosure, measured in accordance with the SLP-2000 Stress Profile Characterization Method;

FIG. 8 is a plot showing averaged retardance in degrees (y-axis) as a function of depth (x-axis) for a comparative example, measured in accordance with the SLP-2000 Stress Profile Characterization Method;

FIG. 9 is a plot showing the symmetric and anti-symmetric components of the averaged retardance curve of FIG. 7, having the origin at the mid-plane between the retardation turning points where the stress crosses zero (changes between tension and compression), along with a fitted power model to the anti-symmetric component;

FIG. 10 is a plot showing the symmetric and anti-symmetric components of the averaged retardance curve of FIG. 8, having the origin at the mid-plane between the retardation turning points where the stress crosses zero (changes between tension and compression), along with a fitted power model to the anti-symmetric component;

FIG. 11 is a plot showing the residuals between the anti-symmetric component of the averaged retardation of FIG. 7 and the fitted power model of the same;

FIG. 12 is a plot showing the residuals between the anti-symmetric component of the averaged retardation of FIG. 8 and the fitted power model of the same;

FIG. 13 is a plot showing the stress profile of the fitted power model for the chemically strengthened glass-based article of which the averaged retardance curve is shown in FIG. 7, where tension (y-axis) is plotted as a function of depth (x-axis); and

FIG. 14 is a plot showing the stress profile of the fitted power model for the comparative example of which the averaged retardance curve is shown in FIG. 8, where tension (y-axis) is plotted as a function of depth (x-axis).

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

Reference will now be made in detail to various embodiments strengthened glass-based articles having non-frangible stress profiles. Various embodiments of chemically strengthened glass-based articles and manufacturing methods thereof will be referred to herein with specific reference to the appended drawings.

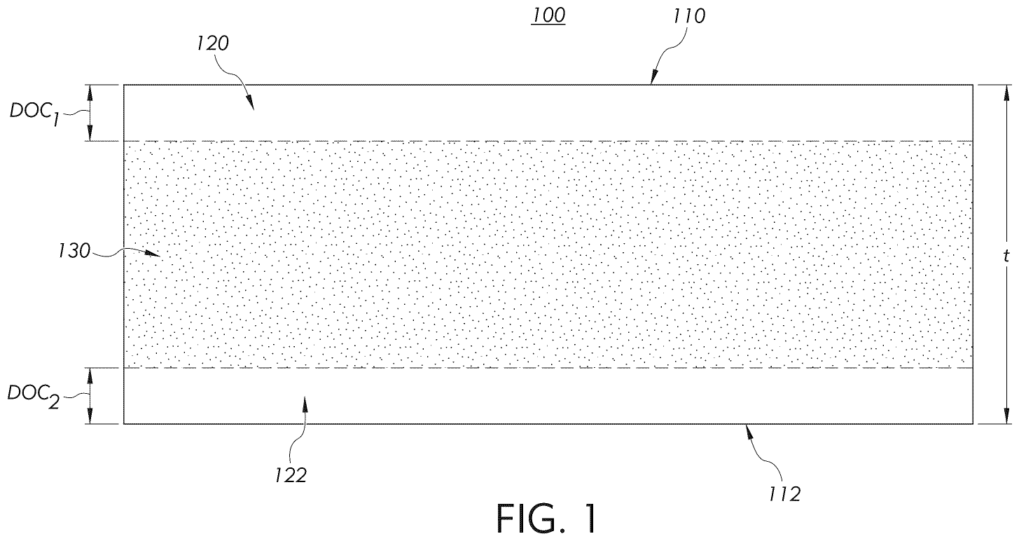

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

Before describing several exemplary embodiments, it is to be understood that the present disclosure is not limited to the details of construction or process steps set forth in the present disclosure. The disclosure provided herein is capable of other embodiments and of being practiced or being carried out in various ways.

The present disclosure describes chemically strengthened glass-based articles comprising: a first major surface and an opposing second major surface defining a thickness t of the glass-based article; a stress profile σ(x) wherein x extends through the thickness t of the glass-based article in a direction normal to the first major surface and the second major surface; a first compressive stress layer extending from the first major surface to a first depth of compression DOC₁ greater than about 0.15 t; a second compressive stress layer extending from the second major surface to a second depth of compression DOC₂ less than or equal to DOC₁; and a central tension zone positioned between the first and second compressive stress layers and comprising a peak tension PT and a breadth of tension zone BTZ spanning DOC₁ to t-DOC₂,
wherein:

$$\frac{DOC}{t} {s}_{σ}^{DOC} > 0.2 MPa / μm ,$$

where DOC=DOC₁ and s_{σ}^{DOC} is the slope of the stress profile σ(x) at DOC;

$$DOC \times {s}_{σ}^{DOC} > 140 MPa ; and$$

$$\frac{TA}{PT \times BTZ} > 0.735 ,$$

where TA is the tension area, defined by:

$$TA = {\int }_{{DOC}_{1}}^{t - {DOC}_{2}} σ ( x ) dx .$$

Without wishing to be bound by theory, it is believed chemically strengthened glass-based articles described herein having the above combination of stress profile attributes demonstrate improved fracture toughness while avoiding frangibility. This is achieved by modifying the stress profile in the central tension zone to achieve increased tension area for a given tensile-strain energy that is selected in view of the fracture toughness of the glass-based article so as to avoid making the glass-based article frangible. The increased tension area TA permits a deep DOC and high levels of compressive stress in the compressive layer while keeping the glass-based article non-frangible. However, the present disclosure also describes chemically strengthened glass-based articles having stress profiles which are modified relative to the above combination of stress profile attributes, for example, in order to account for variations in composition and thickness of the glass-based articles while similarly aiming to improve fracture toughness while avoiding frangibility.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment, or to only one embodiment. Furthermore, the particular features, structures, materials, or characteristics may be combined in any suitable manner in one or more embodiments.

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween.

As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

### Definitions and Measurement Techniques

The terms “glass-based article” and “glass-based substrates” are used to include any object made wholly or partly of glass, including glass-ceramics (including an amorphous phase and a crystalline phase). As utilized herein, a “glass-based substrate” refers to an as formed substrate that may be then be subjected to a strengthening process to form a “glass-based article.” Glass-based substrates according to one or more embodiments can be selected from soda-lime silicate glass, alkali-alumino silicate glass, alkali-containing borosilicate glass, alkali-containing aluminoborosilicate glass, and alkali-containing glass-ceramics.

“Glass-ceramics” include materials produced through controlled crystallization of glass. One or more nucleating agents, for example, titanium oxide (TiO₂), zirconium oxide (ZrO₂), sodium oxide (Na₂O), and phosphorus oxide (P₂O₅) can be added to a glass-ceramic composition to facilitate homogenous crystallization. In some embodiments, the glass-based articles described herein can exhibit an amorphous microstructure and can be substantially free of crystals or crystallites. In other words, the glass-based articles described herein can exclude glass-ceramic materials in some embodiments. In some embodiments, the glass-based articles described herein can include glass-ceramic materials. As such, the terms “glass-based article” and “glass-based articles” are used in their broadest sense to include any object made wholly or partly of glass.

A “base composition” is a chemical make-up of a substrate prior to any ion exchange (IOX) treatment. That is, the base composition is undoped by any ions from IOX. A composition at the center of a glass-based article that has been IOX treated is close to or the same as the base composition when IOX treatment conditions are such that ions supplied for IOX do not diffuse into the center of the substrate. In one or more embodiments, a central composition at the center of the glass-based article comprises the base composition. The “base composition” may also be referred to herein as the “glass composition.”

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass-based article that is “substantially free of MgO” is one in which MgO is not actively added or batched into the glass-based article, but may be present in very small amounts as a contaminant (e.g., <0.1 mol %).

Unless otherwise specified, all compositions are expressed in terms of mole percent (mol %). The terms “0 mol %” and “free,” when used to describe the concentration and/or absence of a particular constituent component in a glass composition and the resultant glass-based article, means that the constituent component is not present in the glass composition and the resultant glass-based article.

The term “fracture toughness (K₁c),” as used herein, represents the ability of a glass-based article to resist fracture. Fracture toughness is measured on a non-strengthened glass-based article, such as measuring the K_{IC} value prior to ion-exchange (IOX) treatment of the glass-based article, thereby representing a feature of a glass-based substrate prior to ion-exchange. The fracture toughness test methods described herein are not suitable for glasses that have been exposed to ion-exchange treatment. But, fracture toughness measurements performed as described herein on the same glass prior to ion-exchange treatment (e.g., glass-based substrates) correlate to fracture toughness after ion-exchange treatment, and are accordingly used as such. The chevron notched short bar (CNSB) method utilized to measure the Kc value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). The double torsion method and fixture utilized to measure the K_{IC} value is described in Shyam, A. and Lara-Curzio, E., “The double-torsion testing technique for determination of fracture toughness and slow crack growth of materials: A review,” J. Mater. Sci., 41, pp. 4093-4104, (2006). The double torsion measurement method generally produces Kc values that are slightly higher than the chevron notched short bar method. Unless otherwise specified, all fracture toughness values were measured by chevron notched short bar (CNSB) method.

The elastic modulus (also referred to as Young's modulus) and the shear modulus of the glass-based article, as described herein, are provided in units of gigapascals (GPa) and measured in accordance with ASTM C623. Poisson's ratio, as described herein, is also measured in accordance with ASTM C623.

The term “strain point,” as used herein, refers to the temperature at which the viscosity of the glass composition is 1×10^{14.68} poise as measured in accordance with ASTM C598.

The term “annealing point” or “effective annealing temperature,” as used herein, refers to the temperature at which the viscosity of the glass composition is 1×10^{13.18} poise as measured in accordance with ASTM C598.

The term “softening point,” as used herein, refers to the temperature at which the viscosity of the glass composition is 1×10^{7.6} poise. The softening point is measured according to the parallel plate viscosity method which measures the viscosity of inorganic glass from 10⁷ to 10⁹ poise as a function of temperature, similar to ASTM C1351M.

The term “melting point,” as used herein, refers to the temperature at which the viscosity of the glass composition is 200 poise as measured in accordance with ASTM C338.

The term “linear coefficient of thermal expansion” and “CTE,” as described herein, may be measured in accordance with ASTM E228-85 over the temperature range of 25° C. to 300° C. and is expressed in terms of “×10⁻⁶/° C.” The terms “low temperature CTE” or “LTCTE,” as used herein, refer to the CTE of the glass composition measured at specific temperatures ranging from 50° C. to 500° C. The terms “high temperature CTE” or “HTCTE,” as used herein, refer to the CTE of the glass composition at the minimum temperature at which the glass has a viscosity of 10¹¹ Poise (the T₁₁ temperature). CTE is measured by digital image correlation, which determines thermal expansion and instantaneous coefficient of thermal expansion of a glass composition on cooling through the glass transition zone with a cooling rate of 2° C./s.

Density, as described herein, is measured by the buoyancy method of ASTM C693-93.

Refractive index, as described herein, is measured in accordance with ASTME1967.

A “stress profile” is a plot of stress as a function of depth across the thickness of a glass-based article. A compressive stress region, where the article is under compressive stress, extends from a first surface to a depth of compression (DOC) of the article. A central tension zone extends from the DOC and includes the region where the glass-based article is under tensile stress.

As used herein, the terms “depth of compression” and “DOC” refer to the depth at which the stress within the glass changes from compressive to tensile stress. At the DOC, the stress crosses from a positive (compressive) stress to a negative (tensile) stress and thus has a value of zero. However, when used with the term “tensile,” stress in the central tension zone may be expressed as a positive value.

A “surface spike” refers to the region of a stress profile where the compressive stress decreases rapidly from a maximum at the surface to a depth generally about 15 to 20 μm below the surface, before decreasing much less rapidly to a point at which the stress transitions from a compressive stress to a tensile stress.

A “knee” of a stress profile is a region of an article having a surface spike where the slope of the stress profile transitions from steep (the spike region) to gradual (a deep region). The steep portion of the stress profile extending from the surface into the glass-based article is referred to as the “spike.” The knee may refer to a transition area over a span of depths where the slope is changing. The knee compressive stress (CSₖ) is defined as the value of compressive stress that the deeper portion of the CS profile extrapolates to at the depth of spike (DOLₛₚ). The DOL_{SP} refers to the depth of the knee and may be measured by a surface-stress meter using known methods (see U.S. patent Ser. No. 11/402,366, titled “Methods of Characterizing Ion-Exchanged Chemically Strengthened Gasses Containing Lithium”).

A non-zero metal oxide concentration that varies from the first surface to a depth of layer (DOL) with respect to the metal oxide or that varies along at least a substantial portion of the article thickness (t) indicates that a stress has been generated in the article as a result of ion exchange. The variation in metal oxide concentration may be referred to herein as a metal oxide concentration gradient. The metal oxide that is non-zero in concentration and varies from the first surface to a DOL or along a portion of the thickness may be described as generating a stress in the glass-based article. The concentration gradient or variation of metal oxides is created by chemically strengthening a glass-based substrate in which a plurality of first metal ions in the glass-based substrate is exchanged with a plurality of second metal ions.

As used herein, the terms “depth of exchange,” “depth of layer” (DOL), “chemical depth of layer,” and “depth of chemical layer” may be used interchangeably, describing in general the depth at which ion exchange facilitated by an ion exchange process (IOX) takes place for a particular ion. DOL refers to the depth within a glass-based article (i.e., the distance from a surface of the glass-based article to its interior region) at which an ion of a metal oxide or alkali metal oxide (e.g., the metal ion or alkali metal ion) diffuses into the glass-based article where the concentration of the ion reaches a minimum value, as determined by Glow Discharge-Optical Emission Spectroscopy (GD-OES)). In some embodiments, the DOL is given as the depth of exchange of the slowest-diffusing or largest ion introduced by an ion exchange (IOX) process.

A cross-sectional schematic view of a chemically strengthened glass-based article is shown in FIG. 1. The glass-based article 100 has a thickness t, first surface 110, and second surface 112. While the embodiment shown in FIG. 1 depicts glass-based article 100 as a flat planar sheet or plate, the glass-based article may have other configurations, such as three dimensional shapes or other non-planar configurations. The glass-based article 100 has a first compressive stress layer 120 extending from the first surface 110 to a depth of compression DOC₁ into the bulk of the glass-based article 100. In the embodiment shown in FIG. 1, glass-based article 100 also has a second compressive stress layer 122 extending from the second surface 112 to a second depth of compression DOC₂. In embodiments, DOC₂ is less than or equal to DOC₁. The glass-based article 100 also has a central tension zone 130 that extends from DOC₁ to DOC₂. Center tension CT refers to the tensile stress in the middle of the central tension zone 130, which, when DOC₁ and DOC₂ are equal, coincides 0.5×t. Peak tension PT refers to the maximum tensile stress in the central tension zone 130. It is very common that CT and PT are the same, but this is not a requirement.

The tensile stress in the central tension zone 130 balances or counteracts the compressive stresses of stress layers 120 and 122. The depths of compression DOC₁, DOC₂ of first and second compressive stress layers 120, 122 protect the glass-based article 100 from the propagation of flaws introduced by sharp impact to first and second surfaces 110, 112 of glass-based article 100, while the magnitude of the compressive stress minimizes the likelihood of a flaw penetrating through the depth DOC₁, DOC₂ of first and second compressive stress layers 120, 122.

The CT and PT values may be measured using a Scattered Light Polariscope (SCALP), such as a SCALP-05 portable scattered light polariscope. The Refracted near-field (RNF) method or SCALP may be used to measure the stress profile and the depth of compression (DOC). When the RNF method is utilized to measure the stress profile, the peak tension PT value provided by SCALP is utilized in the RNF method. In particular, the stress profile measured by RNF may be force balanced and calibrated to the peak tension PT value provided by a SCALP measurement. The RNF method is described in U.S. Pat. No. 8,854,623, titled “Systems and methods for measuring a profile characteristic of a glass sample,” which is incorporated herein by reference in its entirety. In particular, the RNF method includes placing the glass article adjacent to a reference block, generating a polarization-switched light beam that is switched between orthogonal polarizations at a rate of from 1 Hz to 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

As used herein, CS refers to the peak compressive stress in the glass-based article, which for many embodiments, is the surface compressive stress, i.e., the compressive stress as the first and second surfaces 110, 112. As such, unless otherwise specified, CS refers to the surface compressive stress. However, in embodiments, the chemically strengthening process may be designed such that the peak compressive stress CS is not at the surface of the glass-based article, but rather embedded within the glass-based article. The relationship between the peak compressive stress CS and peak tension PT may, in some embodiments, be approximated by the expression:

$$PT = ( CS \cdot DOC ) / ( t - 2 DOC ) \qquad Equation 1$$

In various sections of the disclosure, the peak tension PT and maximum compressive stress CS are expressed in megaPascals (MPa), thickness t is expressed in either microns (m) or millimeters (mm), and depth of compression DOC is expressed in microns (m).

Stress profile attributes of the compressive stress layers, including the surface compressive stress CS, depth of compression DOC (for non-lithium glasses), and depth of spike DOL_{SP} may be measured using those means known in the art. Such means include, but are not limited to, film stress measurement (FSM) using commercially available instruments such as, for example, the FSM-6000 stress meter, manufactured by Luceo Co., Ltd. (Tokyo, Japan), or the like, and methods of measuring compressive stress and depth of compression are described in ASTM 1422C-99, titled “Standard Specification for Chemically Strengthened Flat Glass,” and ASTM 1279.19779 “Standard Test Method for Non-Destructive Photoelastic Measurement of Edge and Surface Stresses in Annealed, Heat-Strengthened, and Fully-Tempered Flat Glass,” the contents of which are incorporated herein by reference in their entirety. Surface stress measurements rely upon the accurate measurement of the stress optical coefficient (SOC), which is related to the birefringence of the glass. The SOC in turn is measured by those methods that are known in the art, such as fiber and four point bend methods, both of which are described in ASTM standard C770-98 (2008), titled “Standard Test Method for Measurement of Glass Stress-Optical Coefficient,” the contents of which are incorporated herein by reference in their entirety, and a bulk cylinder method.

Stress profile attributes of the compressive stress layers may be measured using a prism-coupling instrument similar to FSM-6000, but with additional options for the operating wavelength that provides for a preferred measurement window, as described in U.S. Pat. No. 11,448,595, issued Sep. 20, 2022, entitled “Prism-Coupling Systems and Methods with Improved Intensity Transition Position Detection and Tilt Compensation,” the entirety of which is incorporated herein by reference.

For strengthened glass-based articles in which the compressive stress layers extend to deeper depths within the glass, the FSM technique may suffer from contrast issues, which affect the observed DOC value. At deeper DOC values, there may be inadequate contrast between the transverse electric (TE) and transverse magnetic (TM) spectra, thus making the calculation of the difference between TE and TM spectra- and determining the DOC-more difficult. Moreover, the FSM technique is incapable of determining the compressive stress profile (i.e., the variation of compressive stress as a function of depth within the glass). In addition, the FSM technique is incapable of determining the depth of layer resulting from the ion exchange of certain elements such as, for example, lithium.

The techniques described below have been developed to more accurately determine the depth of compression (DOC) and compressive stress profiles for strengthened glass-based articles.

In U.S. patent application Ser. No. 13/463,322, titled “Systems And Methods for Measuring the Stress Profile of Ion-Exchanged Glass” (hereinafter referred to as “Roussev I”), filed by Rostislav V. Roussev et al. on May 3, 2012, and claiming priority to U.S. Provisional Patent Application No. 61/489,800, having the same title and filed on May 25, 2011, two methods for extracting detailed and precise stress profiles (stress as a function of depth) of tempered or chemically strengthened glass are disclosed. The spectra of bound optical modes for TM and TE polarization are collected via prism coupling techniques, and used in their entirety to obtain detailed and precise TM and TE refractive index profiles n_{TM}(z) and n_{TE}(z). The contents of the above applications are incorporated herein by reference in their entirety.

In one embodiment, the detailed index profiles are obtained from the mode spectra by using the inverse Wentzel-Kramers-Brillouin (IWKB) method.

In another embodiment, the detailed index profiles are obtained by fitting the measured mode spectra to numerically calculated spectra of pre-defined functional forms that describe the shapes of the index profiles and obtaining the parameters of the functional forms from the best fit. The detailed stress profile S(z) is calculated from the difference of the recovered TM and TE index profiles by using a known value of the stress-optic coefficient (SOC):

$$S ( z ) = [ {n}_{TM} ( z ) - {n}_{TE} ( z ) ] / SOC \qquad Equation 2$$

Due to the small value of the SOC, the birefringence n_{TM}(z)-n_{TE}(z) at any depth z is a small fraction (typically on the order of 1%) of either of the indices n_{TM}(z) and n_{TE}(z). Obtaining stress profiles that are not significantly distorted due to noise in the measured mode spectra requires determination of the mode effective indices with a precision on the order of 0.00001 RIU. The methods disclosed in Roussev I further include techniques applied to the raw data to ensure such high precision for the measured mode indices, despite noise and/or poor contrast in the collected TE and TM mode spectra or images of the mode spectra. Such techniques include noise-averaging, filtering, and curve fitting to find the positions of the extremes corresponding to the modes with sub-pixel resolution.

Similarly, U.S. patent application Ser. No. 14/033,954, titled “Systems and Methods for Measuring Birefringence in Glass and Glass-Ceramics” (hereinafter referred to as “Roussev II”), filed by Rostislav V. Roussev et al. on Sep. 23, 2013, and claiming priority to U.S. Provisional Application Ser. No. 61/706,891, having the same title and filed on Sep. 28, 2012, discloses an apparatus and methods for optically measuring birefringence on the surface of glass and glass ceramics, including opaque glass and glass ceramics. Unlike Roussev I, in which discrete spectra of modes are identified, the methods disclosed in Roussev II rely on careful analysis of the angular intensity distribution for TM and TE light reflected by a prism-sample interface in a prism-coupling configuration of measurements. The contents of the above applications are incorporated herein by reference in their entirety.

Hence, correct distribution of the reflected optical intensity vs. angle is significantly more important than in traditional prism-coupling stress-measurements, where only the locations of the discrete modes are sought. To this end, the methods disclosed in Roussev 1 and Roussev II comprise techniques for normalizing the intensity spectra, including normalizing to a reference image or signal, correction for nonlinearity of the detector, averaging multiple images to reduce image noise and speckle, and application of digital filtering to further smooth the intensity of angular spectra. In addition, one method includes formation of a contrast signal, which is additionally normalized to correct for fundamental differences in shape between TM and TE signals. The aforementioned method relies on achieving two signals that are nearly identical and determining their mutual displacement with sub-pixel resolution by comparing portions of the signals containing the steepest regions. The birefringence is proportional to the mutual displacement, with a coefficient determined by the apparatus design, which includes prism geometry and index, focal length of the lens, and pixel spacing on the sensor. The stress is determined by multiplying the measured birefringence by a known stress-optic coefficient.

In another method, derivatives of the TM and TE signals are determined after application of some combination of the aforementioned signal conditioning techniques. The locations of the maximum derivatives of the TM and TE signals are obtained with sub-pixel resolution, and the birefringence is proportional to the spacing of the above two maxima, with a coefficient determined as before by the apparatus parameters.

Associated with the requirement for correct intensity extraction, the apparatus comprises several enhancements, such as using a light-scattering surface (static diffuser) in close proximity to or on the prism entrance surface to improve the angular uniformity of illumination, a moving diffuser for speckle reduction when the light source is coherent or partially coherent, and light-absorbing coatings on portions of the input and output facets of the prism and on the side facets of the prism to reduce parasitic background which tends to distort the intensity signal. In addition, the apparatus may include an infrared light source to enable measurement of opaque materials.

Furthermore, Roussev II discloses a range of wavelengths and attenuation coefficients of the studied sample, where measurements are enabled by the described methods and apparatus enhancements. The range is defined by αₛλ<2507πσₛ, where as is the optical attenuation coefficient at measurement wavelength λ, and αₛ is the expected value of the stress to be measured with typically required precision for practical applications. This wide range allows measurements of practical importance to be obtained at wavelengths where the large optical attenuation renders previously existing measurement methods inapplicable. For example, Roussev II discloses successful measurements of stress-induced birefringence of opaque white glass-ceramic at a wavelength of 1550 nm, where the attenuation is greater than about 30 dB/mm.

In embodiments, stress profiles of the chemically strengthened glass-based articles disclosed herein may be measured using a scattered light photoelastic stress meter (SLP), or SLP in combination with FSM. Commercial SLP meters include SLP-1000 and SLP-2000 manufactured by Orihara Industrial Co., Ltd. However, stress profile attributes may also be measured using custom measurement systems. In some cases, custom measurement systems may be capable of providing more accurate measurements than commercially available systems.

It should be noted that when commercial-grade equipment is utilized to measure attributes of the stress profile of glass-based articles, it may be necessary to conduct several measurements, e.g., ten measurements, and to average the retardance data for subsequent analysis and extraction of various attributes of interest discussed in more detail below.

### Base Composition of Glass-Based Articles

In embodiments of the glass-based articles disclosed herein, SiO₂ is the largest constituent and, as such, SiO₂ is the primary constituent of the glass network formed from the composition of the glass-based substrate. Pure SiO₂ has a relatively low CTE and is alkali free. However, pure SiO₂ has a high melting point. Accordingly, if the concentration of SiO₂ in the composition of the glass-based substrate is too high, the formability of the glass composition may be diminished as higher concentrations of SiO₂ increase the difficulty of melting the glass, which in turn, adversely impacts the formability of the glass. In embodiments, the composition of the glass-based substrate may comprise 50.0 to 75.0 mol % SiO₂. In embodiments, the composition of the glass-based substrate may comprise 50.0 to 70.0 mol % SiO₂. In embodiments, the composition of the glass-based substrate may comprise 55.0 to 65.0 mol % SiO₂. In embodiments, the composition of the glass-based substrate may comprise 57.0 to 63.0 mol % SiO₂. In embodiments, the concentration of SiO₂ in the composition of the glass-based substrate may be in the range from 50.0 to 70.0 mol %, from 50.0 to 67.0 mol %, from 50.0 to 65.0 mol %, from 50.0 to 63.0 mol %, from 50.0 to 60.0 mol %, from 55.0 to 70.0 mol %, from 55.0 to 67.0 mol %, from 55.0 to 65.0 mol %, from 55.0 to 64.0 mol %, from 55.0 to 63.0 mol %, from 55.0 to 62.0 mol %, from 55.0 to 61.0 mol %, from 55.0 to 60.0 mol %, from 55.0 to 59.0 mol %, from 56.0 to 70.0 mol %, from 56.0 to 67.0 mol %, from 56.0 to 65.0 mol %, from 56.0 to 64.0 mol %, from 56.0 to 63.0 mol %, from 56.0 to 62.0 mol %, from 56.0 to 61.0 mol %, from 56.0 to 60.0 mol %, from 56.0 to 59.0 mol %, from 57.0 to 70.0 mol %, from 57.0 to 67.0 mol %, from 57.0 to 65.0 mol %, from 57.0 to 64.0 mol %, from 57.0 to 63.0 mol %, from 57.0 to 62.0 mol %, from 57.0 to 61.0 mol %, from 57.0 to 60.0 mol %, from 57.0 to 59.0 mol %, or from 65.0 to 75.0 mol %, or any and all sub-ranges formed from any of these endpoints.

The base compositions or the glass-based articles described herein may further comprise Al₂O₃. Al₂O₃ may serve as a glass network former, similar to SiO₂. Al₂O₃ may increase the viscosity of the composition of the glass-based substrate due to its tetrahedral coordination in a glass melt formed from a composition of the glass-based substrate. If the amount of Al₂O₃ is too high, the formability of the composition of the glass-based substrate may be decreased. However, when the concentration of Al₂O₃ is balanced against the concentration of SiO₂ and the concentration of alkali oxides in the composition of the glass-based substrate, Al₂O₃ may reduce the liquidus temperature of the glass melt. Reducing the liquidus temperature enhances the liquidus viscosity and improves the compatibility of the composition of the glass-based substrate with certain forming processes, such as the fusion forming process. In embodiments, the composition of the glass-based substrate may comprise from 10.0 to 25.0 mol % Al₂O₃. In embodiments, the composition of the glass-based substrate may comprise from 14.0 to 20.0 mol % Al₂O₃. In embodiments, the composition of the glass-based substrate may comprise from 15.0 to 19.0 mol % Al₂O₃. In embodiments, the concentration of Al₂O₃ in the composition of the glass-based substrate may be in the range from 10.0 to 25.0 mol %, from 10.0 to 23.0 mol %, from 10.0 to 20.0 mol %, from 10.0 to 19.0 mol %, from 10.0 to 18.0 mol %, from 12.0 to 25.0 mol %, from 12.0 to 23.0 mol %, from 12.0 to 20.0 mol %, from 12.0 to 19.0 mol %, from 12.0 to 18.0 mol %, from 13.0 to 25.0 mol %, from 13.0 to 23.0 mol %, from 13.0 to 20.0 mol %, from 13.0 to 19.0 mol %, from 13.0 to 18.0 mol %, from 14.0 to 25.0 mol %, from 14.0 to 23.0 mol %, from 14.0 to 20.0 mol %, from 14.0 to 19.0 mol %, from 14.0 to 18.0 mol %, from 15.0 to 25.0 mol %, from 15.0 to 23.0 mol %, from 15.0 to 20.0 mol %, from 15.0 to 19.0 mol %, from 15.0 to 18.0 mol %, from 16.0 to 25.0 mol %, from 16.0 to 23.0 mol %, from 16.0 to 20.0 mol %, from 16.0 to 19.0 mol %, from 16.0 to 18.0 mol %, from 17.0 to 25.0 mol %, from 17.0 to 23.0 mol %, from 17.0 to 20.0 mol %, from 17.0 to 19.0 mol %, or from 17.0 to 18.0 mol %, or any and all sub-ranges formed from any of these endpoints. In embodiments, the concentration of Al₂O₃ in the composition of the glass-based substrate may be greater than or equal to 10.0 mol %, greater than or equal to 11.0 mol %, greater than or equal to 12.0 mol %, greater than or equal to 13.0 mol %, greater than or equal to 14.0 mol %, greater than or equal to 15.0 mol %, greater than or equal to 16.0 mol %, or greater than or equal to 17.0 mol %.

The composition of the glass-based substrate may further comprise B₂O₃. B₂O₃ may be added to the composition of the glass-based substrate as a network former, thereby reducing the meltability and formability of the glass-based substrate. In embodiments, the composition of the glass-based substrate may comprise from 1.0 to 11.0 mol % B₂O₃. In embodiments, the composition of the glass-based substrate may comprise from 2.0 to 10.0 mol % B₂O₃, from 3.0 to 9.0 mol % B₂O₃, from 4.0 to 8.0 mol % B₂O₃, from 5.0 to 7.0 mol % B₂O₃. In embodiments, the concentration of B₂O₃ in the composition of the glass-based substrate may be greater than or equal to 0.5 mol %, greater than or equal to 1.0 mol %, greater than or equal to 1.5 mol %, greater than or equal to 1.0 mol %, greater than or equal to 2.0 mol %, greater than or equal to 2.0 mol %, greater than or equal to 2.5 mol %, greater than or equal to 3.0 mol %, greater than or equal to 3.5 mol %, or greater than or equal to 4.0 mol %.

The composition of the glass-based substrate may further comprise Li₂O. The effect in which Li₂O may have on the fracture toughness is discussed above. Further, the addition of lithium in the glass allows for better control of an ion exchange process and further reduces the softening point of the glass. In embodiments, the composition of the glass-based substrate may comprise 5.0 to 15.0 mol % Li₂O. In embodiments, the composition of the glass-based substrate may comprise 5.0 to 10.0 mol % Li₂O. In embodiments, the composition of the glass-based substrate may comprise 6.0 to 9.0 mol % Li₂O. In embodiments, the concentration of Li₂O in the composition of the glass-based substrate may be in the range from 5.0 to 15.0 mol %, from 5.0 to 10.0 mol %, from 5.0 to 9.0 mol %, from 5.0 to 8.5 mol %, from 5.0 to 8.0 mol %, from 6.0 to 15.0 mol %, from 6.0 to 10.0 mol %, from 6.0 to 9.0 mol %, from 6.0 to 8.5 mol %, from 6.0 to 8.0 mol %, from 6.0 to 7.5 mol %, from 6.0 to 7.0 mol %, from 6.5 to 15.0 mol %, from 6.5 to 10.0 mol %, from 6.5 to 9.0 mol %, from 6.5 to 8.5 mol %, from 6.5 to 8.0 mol %, from 7.0 to 15.0 mol %, from 7.0 to 10.0 mol %, from 7.0 to 9.0 mol %, from 7.0 to 8.5 mol %, from 7.0 to 8.0 mol %, 7.5 to 15.0 mol %, from 7.5 to 10.0 mol %, from 7.5 to 9.0 mol %, or from 7.5 to 8.5 mol %, or any and all sub-ranges formed from any of these endpoints. In embodiments, the concentration of Li₂O in the composition of the glass-based substrate may be less than or equal to 15.0 mol %, less than or equal to 10.0 mol %, less than or equal to 9.5 mol %, less than or equal to 9.0 mol %, less than or equal to 8.5 mol %, or less than or equal to 8.0 mol %. In embodiments, the glass-based substrate comprises greater than or equal to 9 mol % Li₂O, greater than or equal to 10 mol % Li₂O, greater than or equal to 10.5 mol % Li₂O, greater than or equal to 11 mol % Li₂O, greater than or equal to 11.5 mol % Li₂O, or greater than or equal to 12 mol % Li₂O.

The composition of the glass-based substrates described herein may further comprise alkali metal oxides other than Li₂O, such as Na₂O. Na₂O aids in the ion exchangeability of the composition of the glass-based substrate, and also increases the melting point and improves formability of the composition of the glass-based substrate. However, if too much Na₂O is added to the composition of the glass-based substrate, the CTE may be too low and the melting point may be too high. As such, in embodiments, the concentration of Li₂O present in the composition of the glass-based substrate is greater than the concentration of Na₂O present in the composition of the glass-based substrate. In embodiments, the composition of the glass-based substrate may comprise 0.5 to 15.0 mol % Na₂O. In embodiments, the composition of the glass-based substrate may comprise 1.0 to 10.0 mol % Na₂O. In embodiments, the composition of the glass-based substrate may comprise 1.0 to 2.0 mol % Na₂O. In embodiments, the composition of the glass-based substrate may comprise 1.0 to 3.0 mol % Na₂O.

The composition of the glass-based substrates described herein may further comprise alkali metal oxides other than Li₂O and Na₂O, such as K₂O. K₂O promotes ion exchange and increases the DOC. However, adding K₂O may cause the CTE to be too low and the melting point to be too high. In embodiments, the composition of the glass-based substrate may comprise 0.0 to 1.0 mol % K₂O. In embodiments, the composition of the glass-based substrate may comprise 0.0 to 0.5 mol % K₂O. In embodiments, the composition of the glass-based substrate may comprise 0.0 to 0.4 mol % K₂O. In embodiments, the concentration of K₂O in the composition of the glass-based substrate may be in the range from 0.0 to 1.0 mol %, from 0.0 to 0.5 mol %, from 0.0 to 0.4 mol %, from 0.0 to 0.3 mol %, from 0.0 to 0.2 mol %, or from 0.0 to 0.1 mol %, or any and all sub-ranges formed from any of these endpoints. In embodiments, the composition of the glass-based substrate may comprise less than or equal to 1.0 mol % K₂O, less than or equal to 0.5 mol % K₂O, less than or equal to 0.4 mol % K₂O, less than or equal to 0.3 mol % K₂O, less than or equal to 0.2 mol % K₂O, or less than or equal to 0.1 mol % K₂O.

The composition of the glass-based substrates described herein may further comprise MgO. MgO lowers the viscosity of a glass, which enhances the formability, the strain point, and the Young's modulus, and may improve the ion exchangeability. However, when too much MgO is added to the composition of the glass-based substrate, the density and the CTE of the composition of the glass-based substrate increase. In embodiments, the concentration of MgO in the composition of the glass-based substrate may be in the range from 0.0 to 5.0 mol %, from 0.0 to 4.5 mol %, from 0.0 to 4.0 mol %, from 0.0 to 3.5 mol %, from 0.0 to 3.0 mol %, from 0.0 to 2.5 mol %, from 0.0 to 2.0 mol %, from 0.0 to 1.5 mol %, from 0.5 to 5.0 mol %, from 0.5 to 4.5 mol %, from 0.5 to 4.0 mol %, from 0.5 to 3.5 mol %, from 0.5 to 3.0 mol %, from 0.5 to 2.5 mol %, from 0.5 to 2.0 mol %, from 0.5 to 1.5 mol %, from 1.0 to 5.0 mol %, from 1.0 to 4.5 mol %, from 1.0 to 4.0 mol %, from 1.0 to 3.5 mol %, from 1.0 to 3.0 mol %, from 1.0 to 2.5 mol %, from 1.0 to 2.0 mol %, or from 1.0 to 1.5 mol %, or any and all sub-ranges formed from any of these endpoints. In embodiments, the concentration of MgO is less than or equal to 5.0 mol %, less than or equal to 4.5 mol %, less than or equal to 4.0 mol %, less than or equal to 3.5 mol %, less than or equal to 3.0 mol %, less than or equal to 2.5 mol %, less than or equal to 2.0 mol %, or less than or equal to 1.5 mol %. In embodiments, the concentration of MgO in the composition of the glass-based substrate may be from greater than 0.0 mol % to less than or equal to 3.0 mol %, from greater than 0.0 mol % to less than or equal to 2.5 mol %, from greater than 0.0 mol % to less than or equal to 2.0 mol %, or from greater than 0.0 mol % to less than or equal to 1.5 mol %.

The composition of the glass-based substrates described herein may further comprise CaO. CaO lowers the viscosity of a glass, which enhances the formability, the strain point and the Young's modulus, and may improve the ion exchangeability. However, when too much CaO is added to the composition of the glass-based substrate, the density and the CTE of the composition of the glass-based substrate increase. In embodiments, the concentration of CaO in the composition of the glass-based substrate may be from 0.0 to 5.0 mol %, from 0.0 to 4.0 mol %, from 0.0 to 3.5 mol %, from 0.0 to 3.0 mol %, from 0.0 to 2.5 mol %, from 0.0 to 2.0 mol %, from 0.0 to 1.5 mol %, from 0.0 to 1.0 mol %, from 0.0 to 0.5 mol %, from 0.0 to 0.1 mol %, from 0.5 to 5.0 mol %, from 0.5 to 4.0 mol %, from 0.5 to 3.5 mol %, from 0.5 to 3.0 mol %, from 0.5 to 2.5 mol %, from 0.5 to 2.0 mol %, from 0.5 to 1.5 mol %, from 0.5 to 1.0 mol %, from 1.0 to 5.0 mol %, from 1.0 to 4.0 mol %, from 1.0 to 3.5 mol %, from 1.0 to 3.0 mol %, from 1.0 to 2.5 mol %, from 1.0 to 2.0 mol %, from 1.5 to 5.0 mol %, from 1.5 to 4.0 mol %, from 1.5 to 3.5 mol %, from 1.5 to 3.0 mol %, from 1.5 to 2.5 mol %, from 1.5 to 2.0 mol %, from 2.0 to 5.0 mol %, from 2.0 to 4.0 mol %, from 2.0 to 3.5 mol %, from 2.0 to 3.0 mol %, from 2.0 to 2.5 mol %, from 2.5 to 5.0 mol %, from 2.5 to 4.0 mol %, from 2.5 to 3.5 mol %, or from 2.5 to 3.0 mol %, or any and all sub-ranges formed from any of these endpoints. In embodiments, the concentration of CaO in the composition of the glass-based substrate may be less than or equal to 0.1 mol %. In embodiments, the concentration of CaO in the composition of the glass-based substrate may be from greater than 0.0 mol % to less than 0.1 mol %. In embodiments, the composition of the glass-based substrate may be substantially free or free of CaO.

The composition of the glass-based substrates described herein may further comprise ZnO. In embodiments, the concentration of ZnO in the composition of the glass-based substrate may be from greater than 0.0 mol % to less than or equal to 3.0 mol %.

The composition of the glass-based substrates described herein may further include one or more fining agents. In embodiments, the fining agents may include, for example, SnO₂. In embodiments, the concentration of SnO₂ in the composition of the glass-based substrate may be from 0.0 to 1.0 mol %, from 0.0 to 0.5 mol %, from 0.0 to 0.4 mol %, from 0.0 to 0.3 mol %, from 0.0 to 0.2 mol %, or from 0.0 to 0.1 mol %, or any and all sub-ranges formed from any of these endpoints. In embodiments, the concentration of SnO₂ in the composition of the glass-based substrate may be less than or equal to 0.1 mol %. In embodiments, the concentration of SnO₂ in the composition of the glass-based substrate may be in the range from greater than 0.0 mol % to less than or equal to 0.1 mol %, from greater than 0.0 mol % to less than or equal to 0.5 mol %, or from greater than 0.0 mol % to less than or equal to 1.0 mol %. In embodiments, the composition of the glass-based substrate may be substantially free or free of SnO₂.

The base compositions of the glass-based articles disclosed herein may comprise additional elements and/or oxides as needed for specifically desired properties. For example, TiO₂ may be added to improve the UV absorbance of the composition of the glass-based substrate. Those skilled in the art would understand that it is possible to add additional components to the composition without deviating from the concepts herein disclosed related to the stress profile imparted to the glass-based article via a strengthening process.

In embodiments, the glass-based substrate may comprise: greater than or equal to 50 mol % and less than or equal to 75 mol % SiO₂; greater than or equal to 10 mol % and less than or equal to 25 mol % Al₂O₃; greater than or equal to 1 mol % and less than or equal to 11 mol % B₂O₃; greater than or equal to 1 mol % and less than or equal to 10 mol % Na₂O; and greater than or equal to 5 mol % and less than or equal to 15 mol % Li₂O, wherein a molar concentration of Li₂O in the glass-based substrate is less than a molar concentration of Na₂O in the glass-based substrate.

In embodiments, the glass-based substrate comprises a molar ratio of Li₂O to Na₂O of greater than or equal to 1.0, greater than or equal to 1.5, greater than or equal to 2.0, greater than or equal to 2.5, greater than or equal to 3.0, greater than or equal to 3.5, greater than or equal to 4.0, greater than or equal to 4.5, greater than or equal to 5.0, greater than or equal to 5.5, greater than or equal to 6.0, greater than or equal to 6.5, greater than or equal to 7.0, greater than or equal to 7.5, greater than or equal to 8.0, greater than or equal to 8.5, greater than or equal to 9.0, greater than or equal to 9.5, or greater than or equal to 10.0.

### Ion-Exchange Treatment

As stated above, the glass-based articles may be chemically strengthened by ion exchange treatments. In this process, ions at or near the surface of the glass are replaced by—or exchanged with—larger ions having the same valence or oxidation state. In those embodiments in which the glass-based article comprises, consists essentially of, or consists of an alkali aluminosilicate glass, ions in the surface layer of the glass and the larger ions are monovalent alkali metal cations, such as Li⁺ (when present in the glass), Na⁺, K⁺, Rb⁺, and Cs⁺. Alternatively, monovalent cations in the surface layer may be replaced with monovalent cations other than alkali metal cations, such as Ag⁺ or the like.

Ion exchange processes are typically carried out by immersing a glass-based article in a molten salt bath containing the larger ions that are to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, and additional steps such as annealing, washing, and the like, are generally determined based upon the composition of the glass and the desired depth of layer and compressive stress of the glass that result from the strengthening operation. By way of example, ion exchange of alkali metal-containing glasses may be achieved by immersion in at least one molten bath containing a salt such as, but not limited to, nitrates, sulfates, and chlorides of the larger alkali metal ion. The temperature of the molten salt bath typically is in a range from about 3800° C. up to about 450° C. or to about 460° C., while immersion times range from about 15 minutes up to about 40 hours. However, temperatures and immersion times different from those described above may also be used. For example, one skilled in the art would understand that the thickness of the glass-based substrate to be subjected to ion-exchange treatment may be considered in selecting the temperature of the molten salt bath and the immersion time of the ion-exchange treatment.

In addition, non-limiting examples of ion exchange processes in which glass is immersed in multiple ion exchange baths, with washing and/or annealing steps between immersions, are described in U.S. Pat. No. 8,561,429, by Douglas C. Allan et al., issued on Oct. 22, 2013, titled “Glass with Compressive Surface for Consumer Applications,” and claiming priority from U.S. Provisional Patent Application No. 61/079,995, filed Jul. 11, 2008, in which glass is strengthened by immersion in multiple, successive, ion exchange treatments in salt baths of different concentrations; and U.S. Pat. No. 8,312,739, by Christopher M. Lee et al., issued on Nov. 20, 2012, and titled “Dual Stage Ion Exchange for Chemical Strengthening of Glass,” and claiming priority from U.S. Provisional Patent Application No. 61/084,398, filed Jul. 29, 2008, in which glass is strengthened by ion exchange in a first bath is diluted with an effluent ion, followed by immersion in a second bath having a smaller concentration of the effluent ion than the first bath. The contents of U.S. Pat. Nos. 8,561,429 and 8,312,739 are incorporated herein by reference in their entirety.

The compressive stress is created by chemically strengthening the glass-based article, for example, by the ion exchange processes previously described herein, in which a plurality of first metal ions in the outer region of the glass-based article is exchanged with a plurality of second metal ions so that the outer region comprises the plurality of the second metal ions. Each of the first metal ions has a first ionic radius and each of the second alkali metal ions has a second ionic radius. The second ionic radius is greater than the first ionic radius, and the presence of the larger second alkali metal ions in the outer region creates the compressive stress in the outer region.

At least one of the first metal ions and second metal ions are ions of an alkali metal. The first ions may be ions of lithium, sodium, potassium, and rubidium. The second metal ions may be ions of one of sodium, potassium, rubidium, and cesium, with the proviso that the second alkali metal ion has an ionic radius greater than the ionic radius than the first alkali metal ion.

The term “depth of sodium ion penetration after ion-exchange,” as used herein, refers to the depth within the glass-based article (i.e., the distance from a surface of the glass-based article to its interior region) at which a sodium ion introduced by an ion-exchange process diffuses into the glass-based article where the concentration of the sodium ion reaches a minimum value, as determined by Glow Discharge-Optical Emission Spectroscopy (GD-OES).

The term “depth of potassium ion penetration after ion-exchange,” as used herein, refers to the depth within the glass-based article (i.e., the distance from a surface of the glass-based article to its interior region) at which a potassium ion introduced by an ion-exchange process diffuses into the glass-based article where the concentration of the potassium ion reaches a minimum value, as determined by GD-OES.

As mentioned above, the present disclosure is directed to chemically strengthened glass-based articles that are strengthened so as to achieve deep a DOC and high levels of compressive stress in the compressive layer while also meeting the requirement of non-frangibility. However, several barriers must be overcome in order to obtain a stress profile for a strengthened glass-based article that achieves these features. For example, the ability to induce a stress profile having high DOC may be hindered by a limited concentration of the out-diffusing ion as the desired ion-exchange diffusivity is often dependent on the concentration of the out-diffusing ion species. As such, a limited concentration of the out-diffusing ion species may limit the ability to induce stress in the glass. Exemplary ion-exchange treatment methods which overcome some of these challenges are discussed in more detail herein.

### Non-Frangibility

As discussed above, the strength of a glass-based article subjected to tensile stress is strongly dependent on the depth of sharp flaws extending into the glass from the surface.

During service, a cover glass of an electronic device may be subjected to contact events with rough surfaces that lead to the formation of flaws of varying depths, including significant depths close to, and even exceeding, 100 micrometers (μm). For significant protection against fracture due to relatively deep flaws, it is desirable to make the DOC as high as possible. In addition, during drop events, significant stresses can be induced in the cover glass, especially close to the contact location. The compressive stress in the compressive layer may counteract tensile stresses generated during a drop event. Thus, the level of protection can be further increased when the magnitude of the compressive stress in the compressive layer is higher. Accordingly, in order to provide cover glasses with improved protection against failure, there exists a need for strengthened glass-based articles with deep DOC and high levels of compressive stress in the compressive layer.

Glass-based articles described herein are non-frangible glass-based articles. It is becoming increasingly common for manufacturers of electronic devices having a cover glass to require the cover glass to be non-frangible. Non-frangible glass-based articles described herein do not exhibit frangible behavior (also referred to herein as “frangibility”).

Frangible behavior is the result of sufficient stored strain energy within the article that causes the glass-based article to break in multiple parts (for example, more than three) with several bifurcations. In thermally tempered, laminated, or chemically strengthened (for example, strengthened by ion-exchange) glass-based articles, frangible behavior can occur when the balancing of compressive stresses in a surface or outer region of the glass-based article with tensile stress in the center of the glass-based article provides sufficient energy to cause crack branching with ejection, expulsion, or “tossing” of small glass particles from the article. The velocity at which such ejection occurs is a result of the high amount of tension energy within the glass-based article.

Frangible behavior may be characterized by at least one of: breaking of the strengthened glass-based article (e.g., a plate or sheet) into multiple small pieces (e.g., ≤1 mm); the number of fragments formed per unit area of the glass-based article; multiple crack branching from an initial crack in the glass-based article; violent ejection of at least one fragment to a specified distance (e.g., about 5 cm, or about 2 inches) from its original location; and combinations of any of the foregoing breaking (size and density), cracking, and ejecting behaviors. As used herein, the terms “frangible behavior” and “frangibility” refer to those modes of violent or energetic fragmentation of a strengthened glass-based article absent any external restraints, such as coatings, adhesive layers, or the like. While coatings, adhesive layers, and the like may be used in conjunction with the strengthened glass-based articles described herein, such external restraints are not used in determining the frangibility or frangible behavior of the glass-based articles.

Non-frangible glass-based articles can be made from glass compositions strengthened by one or more strengthening processes configured to impart a desired stress profile in the glass composition, such as the glass compositions and strengthening processes disclosed herein. In some embodiments, the strengthening processes can include one or more ion-exchange processes. In such embodiments, the glass composition from which the non-frangible glass-based articles are made is an ion-exchangeable glass composition. As used herein, “ion-exchangeable” means that a glass composition, or glass-based article comprising the composition, is capable of exchanging first cations located at or near the surface of the substrate with second cations of the same valence. The first cations can be ions of sodium. The second cations can be ions of one of potassium, rubidium, and cesium, with the proviso that the second cation has an ionic radius greater than the ionic radius of the first cation. The first cation is present in the glass composition as an oxide thereof (for example, Na₂O). As used herein, an “ion-exchanged glass-based article” or a “chemically strengthened glass-based article” means the glass-based article has been subject to at least one ion-exchange process that exchanges cations located at or near the surface of the glass with cations of the same valence. In some embodiments, the strengthening processes can include one or more thermal tempering processes. In some embodiments, the strengthening processes can include one or more annealing processes.

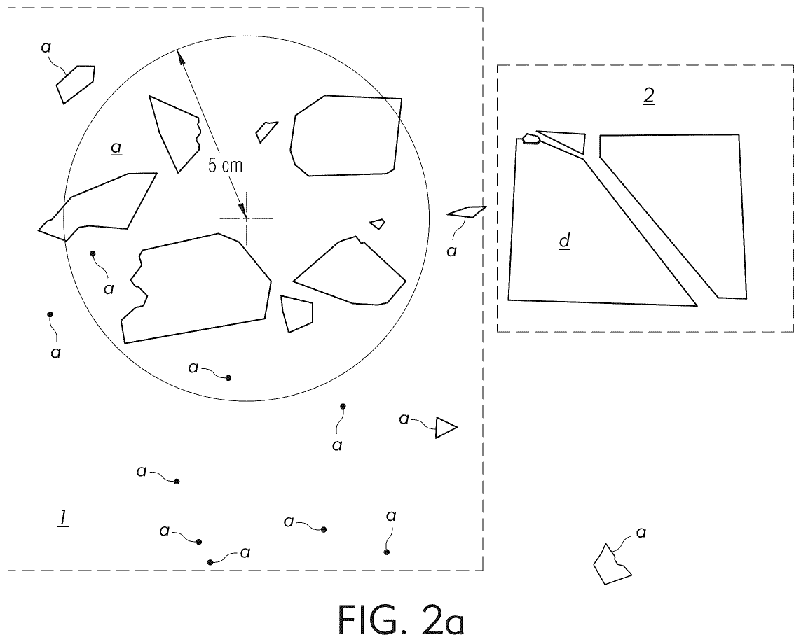

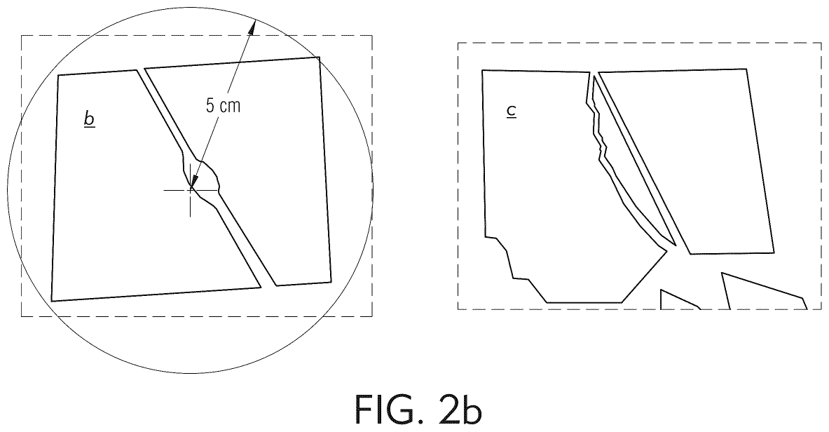

Examples of frangible behavior and non-frangible behavior of strengthened glass-based articles upon point impact with a sharp indenter are shown in FIGS. 2a and 2b. The point impact test that is used to determine frangible behavior includes an apparatus that is delivered to the surface of the glass-based article with a force that is just sufficient to release the internally stored energy present within the strengthened glass-based article. That is, the point impact force is sufficient to create at least one new crack at the surface of the strengthened glass sheet and extend the crack through the compressive stress layers into the region that is under tension. The impact energy needed to create or activate the crack in a strengthened glass sheet depends upon the compressive stress in the compressive stress layers and depth of compression DOC of the article, and thus upon the conditions under which the sheet was strengthened (i.e., the conditions used to strengthen a glass by ion exchange). Otherwise, each ion exchanged glass plate shown in FIGS. 2a and 2b was subjected to a sharp dart indenter (e.g., a SiC indenter) contact sufficient to propagate a crack into the inner region of the plate, the inner region being under tensile stress. The force applied to the glass plate was just sufficient to reach the beginning of the inner region, thus allowing the energy that drives the crack to come from the tensile stresses in the inner region rather than from the force of the dart impact on the outer surface. The degree of ejection may be determined, for example, by centering the glass sample on a grid, impacting the sample, and measuring the ejection distance of individual pieces using the grid.

Referring to FIG. 2a, glass plate a can be classified as being frangible. In particular, glass plate a fragmented into multiple small pieces that were ejected, and exhibited a large degree of crack branching from the initial crack to produce the small pieces. Approximately 50% of the fragments are less than 1 mm in size, and it is estimated that about 8 to 10 cracks branched from the initial crack. Glass pieces were also ejected about 5 cm from original glass plate a, as seen in FIG. 2a. A glass-based article that exhibits any of the three criteria (i.e., multiple crack branching, ejection, and extreme fragmentation) described hereinabove is classified as being frangible. For example, if a glass exhibits excessive branching alone but does not exhibit ejection or extreme fragmentation as described above, the glass is still characterized as frangible.

Glass plates b, c, (FIG. 2b) and d (FIG. 2a) are classified as not frangible. In each of these samples, the glass sheet has broken into a small number of large pieces. Glass plate b (FIG. 2b), for example, has broken into two large pieces with no crack branching; glass plate c (FIG. 2b) has broken into four pieces with two cracks branching from the initial crack; and glass plate d (FIG. 2a) has broken into four pieces with two cracks branching from the initial crack. Based on the absence of ejected fragments (i.e., no glass pieces forcefully ejected more than 2 inches from their original location), there are no visible fragments with a size of 1 mm or less, and the minimal amount of observed crack branching, samples b, c, and d are classified as non-frangible or substantially non-frangible.

### Stress Profiles for the Compressive Stress Lavers

The chemically strengthened glass-based articles of the present disclosure exhibit improved fracture resistance and non-frangibility, in combination, by having stress profiles (induced through particular chemical strengthening processes) with particular attributes that are believed to result in these mechanical properties. These attributes are described in detail below.

In glass-based articles exhibiting a surface spike, the surface spike consumes a substantial portion of the compressive stress area to protect the glass-based article from relatively low penetrating, but leads to lower compressive stress levels (for the same compressive stress area) deep into the compressive stress layer where the tips of deep flaws may be present. Hence, the protective effect of the surface spike is not very useful for protecting against damage resulting from deep flaws. This is especially the case when the surface compressive stress is so concentrated that the near-surface facets of the crack (e.g., flaw) do not separate during a bending event that imposes externally applied tensile stress.

Two compression layer parameters of glass-based articles according to embodiments of the present disclosure include the deep compressive-stress area (CSA_{deep}) and the average deep compressive stress (C̅S̅_̅{̅d̅e̅e̅p̅}̅) in the compression region excluding the surface spike. Without being bound by any particular theory, it is believed that as these attributes of the stress profile are increased, the fracture resistance improves with respect to deep flaws (from several tens of μm to deeper than 100 μm).

These two parameters of the deep compressive stress region are defined as follows:

$${CSA}_{deep} = {{\int }^{DOC}}_{{DOL}_{sp}} σ ( x ) dx \qquad Equation 3$$

$$\overline{{CS}_{deep}} = \frac{{CSA}_{deep}}{DOC - {DOL}_{sp}} \qquad Equation 4$$

where σ(x) refers to the stress profile, DOC refers to the depth of the compressive stress layer (i.e., the depth at which the stress transitions from a compressive stress to a tensile stress), and DOL_{SP} refers to the depth of the knee (i.e., the depth at which the slope of the stress profile transitions from steep (corresponding to the surface spike) to gradual). These parameters may be used to evaluate the fracture resistance of the glass-based article against deep flaws with tips at depths comparable to the DOC. In the context of the present disclosure, references to DOC, i.e., as opposed to DOC₁ or DOC₂, refer to the depth of compression DOC₁. However, in contexts wherein “DOC” is used with reference to the second compressive layer, it refers to the depth of compression of the second compressive stress layer regardless.

A more refined parameter of the strengthening that may be a good predictor of improved fracture resistance on rough surfaces compared to previously known glass-based articles is the stress-intensity factor K_{R}:

$${K}_{R} = \frac{ψ}{\sqrt{π c}} {{\int }^{c}}_{0} σ ( x ) g ( x ) dx \qquad Equation 5$$

where c is the target flaw depth, ψ is a crack-shape factor usually assumed as 1.12, σ(x) is the stress profile, and g(x) is the Green's function which depends on the particular situation (see Vincenzo M. Sglavo & Luca Larentis, “Flaw-insensitive ion-exchanged glass: I, Theoretical Aspects,” J. Am. Ceram. Soc., 84 [8], 1827-31 (2001)). A Green's function that is representative of the majority of cases of interest is that for a crack extending from the surface and normal to it, under externally applied tensile stress that is approximately constant along the crack extent and normal to it:

$$g ( x ) = \frac{2 c}{\sqrt{{c}^{2} - {x}^{2}}} \qquad Equation 6$$

In particular, the value of K_{R} corresponding to a flaw depth c that is equal to DOC may be represented by:

$${K}_{R} ( DOC ) = \frac{ψ}{\sqrt{π DOC}} {{\int }^{DOC}}_{0} {σ}_{R} ( x ) g ( x ) dx \qquad Equation 7$$

After setting the crack-shape factor to 1.12 and inputting the above Green's function approximation the stress-intensity factor K_{R} is:

$${K}_{R} ( DOC ) \approx \frac{1.12 \times 2 DOC}{\sqrt{π DOC}} {{\int }^{DOC}}_{0} \frac{{σ}_{R} ( x )}{\sqrt{{DOC}^{2} - {x}^{2}}} dx \qquad Equation 8$$

It has been found that due to the generally continuous and mostly monotonic nature of the stress profiles obtained by diffusion, each of these three parameters (CSA_{deep}, C̅S̅_̅{̅d̅e̅e̅p̅}̅, and K_{R}(DOC)) is useful for evaluating the protection offered by chemical strengthening induced stress profiles with respect to flaws having a wide range of relatively large depths, such as from about 0.5DOC to DOC, and even slightly beyond the DOC. As these parameters are increased, it is believed that the glass-based article will exhibit greater protection against flaws penetrating deep into the compressive layer. The parameter K_{R}(DOC) may allow for a more precise evaluation of the protective effect for glass-based articles with small-to-moderate thicknesses (0.4 mm to 0.7 mm), as the deeper flaws will tend to have flaw-depths that are comparable to the DOC. That said, calculating K_{R}(DOC) requires slightly more work in order to circumvent the pole associated with the point x=DOC, which is the upper limit of integration. This can be done by limit analysis of the integrant in the vicinity of the pole. Alternatively, a similarly good parameter can be chosen that completely avoids this slight complication, allowing for the integral to be directly evaluated numerically, such as K_{R}(0.95DOC):

$${K}_{R 0.95} ≡ {K}_{R} ( 0.95 DOC ) = \frac{1.12 \times 1.9 DOC}{\sqrt{0.95 π DOC}} {{\int }^{0.95 DOC}}_{0} \frac{{σ}_{R} ( x )}{{( 0.95 DOC )}^{2} - {x}^{2}} dx \qquad Equation 9$$

It has been found that the above parameters representing different stress profile attributes of the deep compression region allow effective comparison of different generations of high-DOC stress profiles for any chosen particular thickness in terms of projected fracture-resistance during drops on rough surfaces. This is in large part because the DOC/thickness ratio for Li-glass profiles is approximately the same due to the substantially maximized DOC for thicknesses below about 0.8 mm (the force-balance sets a maximum DOC for conventional chemical strengthening of Li-based glasses). That DOC is usually around 20% of thickness, though in some cases it is somewhat smaller or somewhat larger, depending on the specifics of the process (single or dual ion exchange), the glass composition and its interaction with the concentration-dependence of the diffusion coefficient, and the degree of stress relaxation. Moreover, C̅S̅_̅{̅d̅e̅e̅p̅}̅ and K_{R}(DOC) (or K_{R0.95}) may be normalized to account for slight variations of the DOC/thickness ratio, as follows:

$$\overline{{CS}_{deep} N} = \overline{{CS}_{deep}} \frac{DOC}{0.2 t} \qquad Equation 10$$

$$and$$

$${K}_{R}^{N} ( DOC ) \approx \frac{DOC}{0.2 t} {K}_{R} ( DOC ) \qquad Equation 11$$

where N stands for “normalized” and the DOC normalization was chosen relative to 0.2 t to make the normalized C̅S̅_̅{̅d̅e̅e̅p̅}̅N̅ and K_{R}(DOC) have similar values to the average compressive stress and the actual K_{R}, on account that DOC will be as usual on the order of 0.2 t.

It has been found that glasses having higher fracture toughness may exhibit a more peaked tension zone (p<2), higher PT, and thus, advantageously, higher values for σ̅ₜ, CSA_{deep} (Equation 3), C̅S̅_̅{̅d̅e̅e̅p̅}̅ (Equation 4), and K_{R}(DOC) (Equation 7). Without wishing to be bound by theory, this is believed to be due in part to the lower Na/Li ratio in the glass-based substrate.

In embodiments, when the composition of the glass-based article comprises less than 3 mol % Li₂O, the fracture toughness K_{IC} of the glass-based article may be greater than or equal to 0.720 MPa\sqrt{m} in a position xₚₑₐₖ in the central tension zone 130 corresponding with the peak tension PT. In embodiments, when the composition of the glass-based article comprises Li₂O in an amount in the range from about 3.0 mol % to about 7.5 mol %, the fracture toughness K_{IC} of the glass-based article may be greater than or equal to 0.810 MPa\sqrt{m} in a position xₚₑₐₖ in the central tension zone 130 corresponding with the peak tension PT. In embodiments, when the composition of the glass-based article comprises Li₂O in an amount in the range from about 7.5 mol % to about 11 mol %, the fracture toughness K_{IC} of the glass-based article may be greater than or equal to 0.850 MPa\sqrt{m} in a position xₚₑₐₖ in the central tension zone 130 corresponding with the peak tension PT. In embodiments, when the composition of the glass-based article comprises Li₂O in an amount in the range from about 11 mol % to about 13 mol %, the fracture toughness K_{IC} of the glass-based article may be greater than or equal to 0.870 MPa\sqrt{m} in a position xₚₑₐₖ in the central tension zone 130 corresponding with the peak tension PT. In embodiments, when the composition of the glass-based article comprises Li₂O in an amount greater than about 13 mol % Li₂O, the fracture toughness K_{IC} of the glass-based article may be greater than or equal to 0.950 MPa\sqrt{m} in a position xₚₑₐₖ in the central tension zone 130 corresponding with the peak tension PT.

In embodiments, the fracture toughness K_{IC} of the glass-based article may be greater than or equal to 1.0 MPa\sqrt{m}, greater than or equal to 1.05 MPa\sqrt{m}, greater than or equal to 1.1 MPa\sqrt{m}, greater than or equal to 1.15 MPa\sqrt{m}, greater than or equal to 1.2 MPa\sqrt{m}, or greater than or equal to 1.2 MPa\sqrt{m}. In embodiments wherein the glass-based article is an amorphous phase substantially free of crystallites, the the fracture toughness K_{IC} of the glass-based article may be less than or equal to 1.1 MPa\sqrt{m}, less than or equal to 1.05 MPa\sqrt{m}, less than or equal to 1.0 MPa\sqrt{m}, less than or equal to 0.95 MPa\sqrt{m}, less than or equal to 0.90 MPa\sqrt{m}, or less than or equal to 0.85 MPa\sqrt{m}.

With respect to glass-based articles ion-exchanged so as to have a surface spike, it has been recognized that increasing the levels of deep compressive stress disposed between DOLₛₚ and DOC should be pursued in at least three cases of interest: (i) cover glasses with high fracture toughness and reduced thickness (mainly 0.4 mm to 0.6 mm, more generally up to 0.65 mm or 0.7 mm, and as low as 0.35 mm or 0.30 mm); (ii) cover glasses with shaped edges that locally have reduced or further reduced thickness (2.5D-shaped edges); and (iii) 3D-shaped cover glasses, especially those with reduced thickness (e.g., 0.4 mm to 0.6 mm).

In the case of thin or 3D-shaped cover glasses, the importance of higher deep compressive stress is raised due to the tendency for the generation of more localized bending upon contact, and hence higher localized bending stresses. For glass-based articles comprising 2.5D-shaped edges, the stress profiles may have higher levels of deep compressive stress in the thicker wider area of the sheet to achieve higher levels of deep compressive stress in the reduced-thickness 2.5D edge of the sheet for at least one relevant stress component, thus decreasing the fracture risk when the contact event occurs on the 2.5D edge.

As discussed above, increasing the level of deep compressive stress beyond the state-of-the-art is difficult to achieve without making the glass frangible, as increased deep compressive stresses will be accompanied by an increase of the tensile stress in the central tension zone 130 due to the force-balance between the integrated compressive stress and integrated tensile stress. Unless the glass-based substrate has a substantially higher fracture toughness, such an increase in the tensile stress would result in the strengthened glass article being frangible. Transparent glass ceramics with substantially better fracture toughness than typical cover glasses have been invented and have indeed entered the market successfully, but the cost of glass-ceramic covers is at present significantly higher than that of glass covers due to extra processing steps for the glass ceramics, and more expensive processing in general (for example, more expensive polishing). The present disclosure is focused on increasing the levels of deep compressive stress for any fixed material-strength parameters, such that the performance boost produced will be additive with respect to any performance boost based on advancing material mechanical properties such as fracture toughness.

### Stress Profiles for the Central Tension Zone

While the main goal of the present disclosure is to increase the levels of deep compressive stress in the compressive region, important aspects of the disclosure relate to increasing the tension area and/or the average tension in the tension zone without increasing the tensile-stress energy. This is driven by the importance of the tensile-stress energy as a driver for frangibility. Thus, one major aspect of the strengthened glass-based articles of the present disclosure is purposeful shaping of the stress distribution in the tension zone to achieve a more uniform distribution for a particular target high DOC (greater or substantially greater than 15% of thickness, for example). One goal of the present disclosure is to increase fracture resistance of low-to-moderate thickness modern cover glasses. Such cover glasses generally need to have high ratios of DOC to thickness.

The relative uniformity of the tensile-stress distribution is desired because the tensile-strain energy (TSE) is proportional to the depth integral over the central tension zone of the squared tensile stress, whereas the tension area TA (which by force-balance equals the compressive-stress area) is the depth integral over the central tension zone of the tensile stress only. Hence, a less uniform stress distribution would increase the TSE for a fixed TA, and vice-versa. Since frangibility imposes an upper limit on the TSE, the present disclosure seeks to increase TA by improving the uniformity of the tensile-stress distribution in the tension zone. Another reason to focus first on the tension zone is the relative ease of measuring the distribution of stress in the deeper interior of Li-based glasses using scattered-light polarimetry (SLP). Indeed, the measurement of stress distribution in the tension zone of Li-based glasses is usually much more accurate than in the compression region, due to the proximity of the compression region to the surface and strong surface scattering corrupting the data collected for the near-surface region. A secondary reason for more accurate extraction of stress in the tension zone is the finite resolution of the scattered-light polarimetry, which results in reduced accuracy in regions where the profile tends to have high second derivative by absolute value. It is typical for the Li-glass stress profiles to have higher second derivative by absolute value in the compression region, both at the bottom of the spike, and at some deeper locations.

While the tension-zone stress profile attributes are especially applicable to Li-based glasses, they can be used equally as well for Na-based glasses. However, for Na-based glasses, the Inverse Wentzel-Kramers-Brillouin (IWKB) method discussed above provides an alternative method to directly obtain an accurate stress distribution in the compression region, as long as the surface of the glass is flat and the profile is not excessively deep such that it is possible to resolve properly the fringes in the prism-coupling spectrum corresponding to deep modes and obtain their effective indices with high accuracy.

The pursuit of profiles with more uniform tension in the tension zone for the purpose of increasing levels of deep compression while avoiding frangibility is counter-intuitive. Indeed, prior-art profiles having the most uniform tension zone, e.g., the traditional one-step profiles in sodium-aluminosilicates (Gorilla® Glasses 1, 2, and 3) having DOC/t<0.08, and most often DOC/t<0.06, have substantially flat tension zone, wherein the average tension σ̅ₜ is almost identical to the peak tension PT (usually occurring in the mid-plane of the substrate). It has been disclosed that the tension-energy frangibility limit for profiles having significantly larger ratio DOC/t and significantly less uniform distribution in the tension zone, is higher in a non-trivial way. However, the present disclosure describes that by increasing the DOC and utilizing a more uniform tensile stress distribution in the tension zone, it is possible to increase the level of deep compressive stresses in the compression stress layers without increasing the tension strain energy TSE and corresponding frangibility probability.

The tension area (TA) of the stress profile is the depth-integral of the tensile stress over the tension zone of the glass-based article. The central tension zone 130 is defined by the space spanning the DOC of the compressive stress layer on one side of the glass-based article to the DOC of the compressive stress layer on the opposing side of the glass-based article. The tension area TA is calculated according to the following equation:

$$TA = {{\int }^{t - {DOC}_{2}}}_{{DOC}_{1}} σ ( x ) dx \qquad Equation 12$$

where DOC₁ and DOC₂ are the depths of compression from opposite surfaces of the glass-based article and a is the stress in MPa. The TA also equals the sum of the stress areas of the compressive layers on either side of the central tension zone 130 when the in-plane dimensions of the glass-based article are each orders of magnitude greater than the thickness of the glass-based article. Unless specified otherwise, the stress and/or energy values for the Equations described herein are positive values. In other words, both compressive and tensile stress and energies are expressed as positive values, i.e., absolute values.

One way to ensure non-frangibility in chemically strengthened glass-based articles is to limit the tension-zone frangibility factor Kₜ while considering the fracture toughness of the glass-based substrate subject to chemical strengthening. The frangibility factor Kₜ is defined as follows:

$${K}_{t} = \sqrt{{{\int }^{t - {DOC}_{2}}}_{{DOC}_{1}} {σ}^{2} dx} \qquad Equation 13$$

In embodiments, the glass-based article may have a frangibility factor Kₜ not exceeding 2.1×K_{IC}, wherein K_{IC} is a fracture toughness of the glass article in a position xₚₑₐₖ in the central tension zone 130 corresponding with the peak tension PT. In embodiments, the glass-based article may have a frangibility factor Kₜ not exceeding 1.97×K_{IC}.

It has been found that the maximum non-frangible PT varies approximately in proportion to the inverse of the square root of the thickness. As such, in embodiments, the PT of the glass-based article induced via chemical strengthening may be set based on the inverse square root of the thickness. In embodiments, the peak tension PT of the glass-based article may be set to be greater than

$$A \frac{{K}_{IC}}{\sqrt{t}} ,$$

where A is equal to 2.5, 2.6, 2.7, 2.8, or 2.9. In embodiments, A is equal to 3.0, 3.1, 3.2, 3.25, 3.3, or 3.35.

In embodiments, the glass-based article has a peak tension PT of greater than 90 MPa, greater than 92 MPa, greater than 95 MPa, greater than 100 MPa, greater than 103 MPa, greater than 108 MPa, greater than 110 MPa, greater than 113 MPa, or greater than 115 MPa. In embodiments, the glass-based article has a peak tension PT greater than 105 MPa. In embodiments, the glass-based article has a peak tension PT greater than 120 MPa, greater than 125 MPa, or greater than 130 MPa.

In embodiments, the thickness t of the glass-based article may be in the range from about 0.4 mm to about 0.77 mm or from about 0.43 mm to about 0.68 mm. In embodiments, the thickness t of the glass based article may be greater than or equal to 0.40 mm or greater than or equal to 0.43 mm. In embodiments, the thickness t of the glass-based article may be less than or equal to 0.77 mm or less than or equal to 0.68 mm. In embodiments, the thickness t of the glass-based article is less than or equal to 0.52 mm.

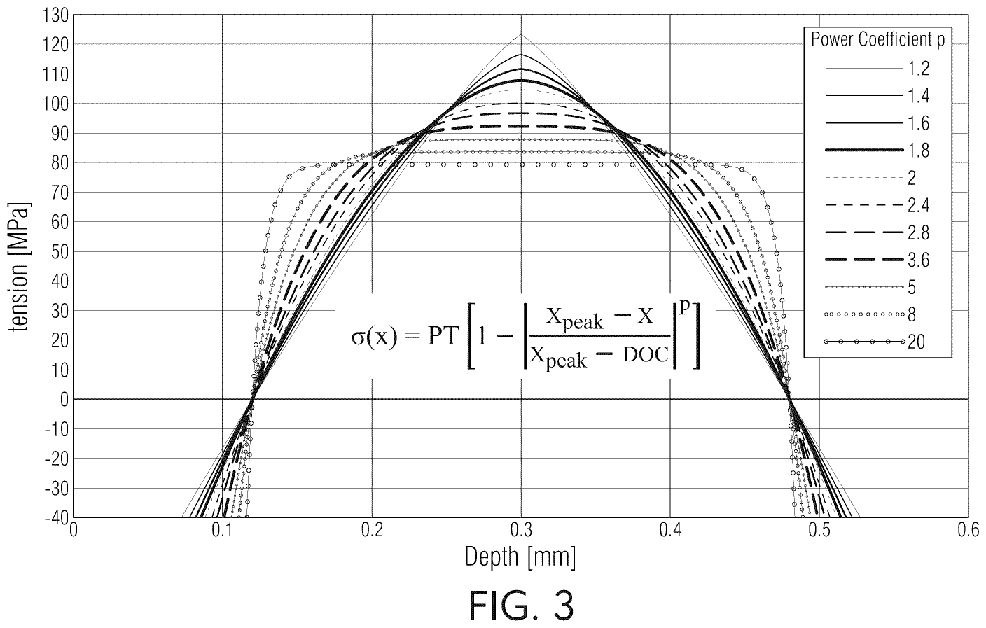

The shape of the stress profile in the tension zone may be approximated with a power-shape profile as follows:

$$σ ( x ) = PT [ 1 - {\vert \frac{0.5 t - x}{0.5 t - DOC} \vert}^{p} ] \qquad Equation 14$$

where x is the depth from the surface of the glass-based article, t is the thickness of the glass-based article, and p is the power coefficient of the stress profile, with p being very close to 2 (parabolic profile), although slightly higher (about 2.1). Equation 14 only closely approximates the stress in the tension zone, i.e., DOC≤x≤t−DOC and extrapolation of Equation 14 outside the of tension zone may not necessarily give a good representation of the stress profile in the compression region, especially far from the DOC. FIG. 3 is a plot showing Equation 14 plotted with different power coefficients p (ranging from 1.2 to 20). The DOC in FIG. 3 is fixed at 0.12 mm (20% of the 0.6 mm thickness). Further the stress profiles plotted in FIG. 3 have tension zone Kₜ factors (Equation 13) of 1.45. Each of the stress profiles in FIG. 1 have the same tension energy but different tension areas TA (Equation 12).

It is convenient to use an appropriate model of the stress distribution in the tension zone to illustrate the method of improving the stress profile attributes, as well as to enable accurate measurements of the stress profile attributes even in cases where the measured retardance is relatively noisy, and also for the stress profile attributes containing Kₜ and Kₜ². Indeed, an approximate profile shape in the tension zone can be obtained by differentiating a polynomial fit of the retardance curve, but low-order polynomials tend to poorly fit complex profiles, while higher-order polynomials tend to fit to a lot of the noise. For a symmetric tension-zone profile, the power-profile introduced above in Equation 14 provides a good fitting model for profiles with varying degree of uniformity of tension. The power coefficient p may be considered a degree of uniformity, where low levels of p correspond to less uniform distributions of tension, and higher levels of p correspond to more uniform distributions. When p approaches infinity, strictly speaking, the tension zone is perfectly flat throughout. In practice, p cannot be very high for diffusion profiles which tend to be continuous with gradually changing finite slopes.

In embodiments, the stress profile of the glass-based article, when fit to Equation 14, has a best-fit value of power coefficient p that is greater than or equal to 2.75, greater than or equal to 2.8, greater than or equal to 2.85, greater than or equal to 2.9, greater than or equal to 3.0, greater than or equal to 3.1, or greater than or equal to 3.2. In embodiments, the stress profile of the glass-based article, when fit to Equation 14, has a best-fit value of power coefficient p that does not exceed 20. In embodiments, the stress profile of the glass-based article, when fit to Equation 14, has a best-fit value of power coefficient p that exceeds 2.35, exceeds 2.4, exceeds 2.45, exceeds 2.5, exceeds 2.55, exceeds 2.6, exceeds 2.65, or exceeds 2.7.

The average tension −t in the tension zone is the ratio between the TA and the breadth of the tension zone (BTZ) which, for a symmetric profile, is t−2DOC.

The degree of uniformity of the tensile stress distribution can be evaluated using several different attributes of the stress profile. Some attributes that are most generally applicable (regardless of the shape of the distribution) include the ratios:

$$\frac{TA}{tPT} \qquad Equation 15$$

$$\frac{TA}{BTZ \times PT} ≡ \frac{\overline{{σ}_{t}}}{PT} ( dimensionless ) \qquad Equation 16$$

where BTZ stands for “breadth of the tension zone.” In embodiments, the stress profile attribute shown in Equation 16 may be set to 0.735 or higher for a glass-based article of the present disclosure. In embodiments, the stress profile attribute shown in Equation 16 may be greater than or equal to 0.700, greater than or equal to 0.705, greater than or equal to 0.710, greater than or equal to 0.715, greater than or equal to 0.720, greater than or equal to 0.725, greater than or equal to 0.730, greater than or equal to 0.735, greater than or equal to 0.740, greater than or equal to 0.745, greater than or equal to 0.750, greater than or equal to 0.755, greater than or equal to 0.760, greater than or equal to 0.765, greater than or equal to 0.770, greater than or equal to 0.775, greater than or equal to 0.780, greater than or equal to 0.785, greater than or equal to 0.790, greater than or equal to 0.795, or greater than or equal to 0.800.

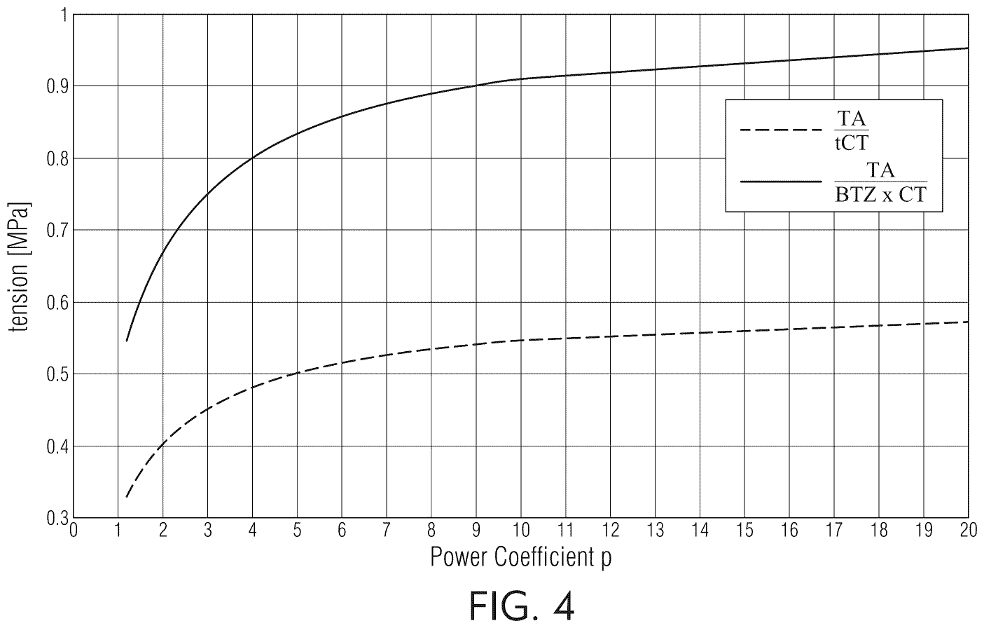

FIG. 4 is a plot showing dimensionless stress profile attributes

$$\frac{TA}{tPT} and \frac{TA}{BTZ \times PT}$$

(y-axis) in terms of power coefficient p (x-axis). FIG. 4 indicates that it may be advantageous to design stress profiles with as high p as possible when a large portion of failures are caused by formation and stressing of flaws that extend to a similar depth as the DOC, preferably not exceeding the DOC significantly.

Other ratios associated with improvement of the stress profile under the limitation of non-frangibility incorporate the tension-zone frangibility factor Kₜ and Kₜ²(proportional to tension energy):

$$\frac{TA}{{K}_{t}} \qquad Equation 17$$

$$\frac{TA}{{K}_{t} \sqrt{t}} ( dimensionless ) \qquad Equation 18$$

$$\frac{TA}{{K}_{t} \sqrt{BTZ}} ( dimensionless ) \qquad Equation 19$$

$$\frac{TA}{{K}_{t}^{2}} \qquad Equation 20$$

$$\frac{TA \overline{{σ}_{t}}}{{K}_{t}^{2}} ( dimensionless ) \qquad Equation 21$$

$$\frac{{TA}^{2}}{{tK}_{t}^{2}} ( dimensionless ) \qquad Equation 22$$

As each of the stress profile attributes shown above are increased, an increased amount of compression will be permitted in the compressive stress layers for a given level of tensile strain energy.

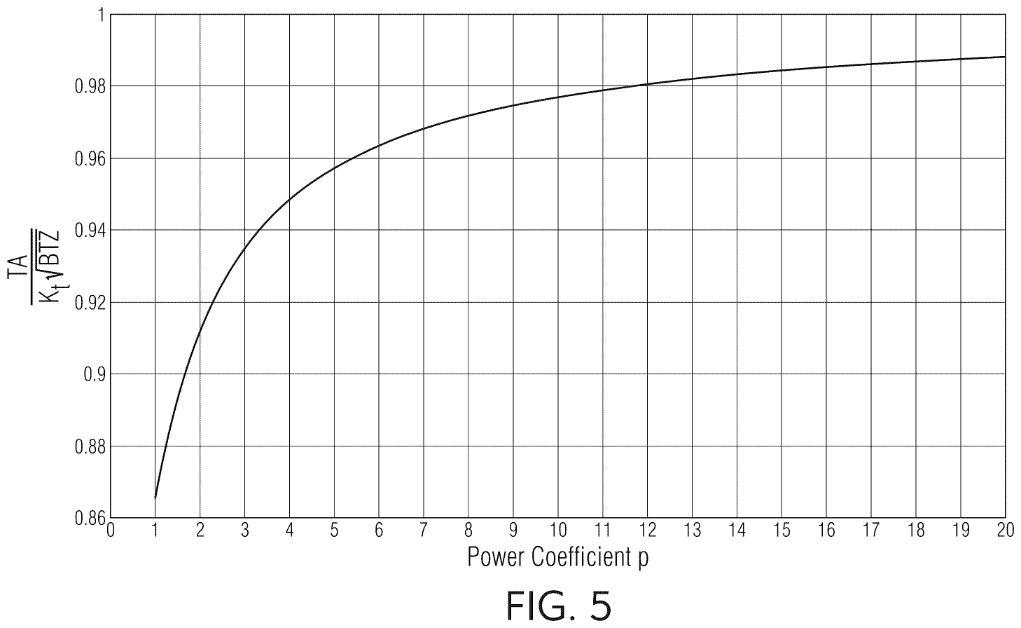

FIG. 5 shows the dimensionless stress profile attribute shown in Equation 19 with power coefficient p varying from 1 to 20. For a fixed breadth of the tension zone (e.g., fixed DOC), profiles with higher p have higher stress area. It should be noted that the stress profile attributes

$$\frac{TA}{{K}_{t} \sqrt{BTZ}} and \frac{TA}{{K}_{t} \sqrt{t}}$$

are related by a constant when the ratio DOC/t is not allowed to vary, so in that case they may be considered equivalent. The stress profile attribute

$$\frac{TA}{{K}_{t} \sqrt{BTZ}}$$

will approach arbitrarily close to 1 when the profile of the tension zone tends toward the perfectly rectangular profile. It can be seen form FIG. 5 that

$$\frac{TA}{{K}_{t} \sqrt{BTZ}}$$

decreases to 0.866 for p=1.2, 0.899 for p=1.6, and 0.913 for p=2. Profiles with p=2 (parabolic) are a good approximation for experimentally possible profiles when the diffusion coefficient may be considered approximately constant over the range of diffusant concentrations represented in the profile, and when the profile has been diffused long enough to achieve maximum or near-maximum DOC. Such profiles are also near or past peak tension PT in terms of diffusion time or diffusion length. It can be seen from FIG. 5 that increasing p above 2.4, for example, allows higher TA for the same Kₜ factor. The rate of gaining TA benefit is high at low values of p, and decreases with increasing p. Hence, the majority of the benefit will be obtained while increasing p from about 2 or less to 3, 4, or 5, without significantly decreasing DOC/t.

Further, again recognizing the importance of high DOC for fracture resistance on rough surfaces, the present disclosure defines parameters of the stress profile indicative of increased levels of deep compressive stress that also explicitly account for improved DOC:

$$\frac{TA}{PT} \frac{DOC}{t} \qquad Equation 23$$

and in a dimensionless form:

$$\frac{TA}{BTZ \times PT} \frac{DOC}{t} ≡ \frac{\overline{{σ}_{t}}}{PT} \frac{DOC}{t} \qquad Equation 24$$

Stress profile attributes explicitly accounting for improved DOC and including ratios of TA to Kₜ or Kₜ include:

$$\frac{TA}{{K}_{t}} \frac{DOC}{t} \qquad Equation 25$$

$$\frac{TA}{{K}_{t} \sqrt{t}} \frac{DOC}{t} ( dimensionless ) \qquad Equation 26$$

$$\frac{TA}{{K}_{t}^{2}} \times \frac{DOC}{t} \qquad Equation 27$$

$$\frac{TA \overline{{σ}_{t}}}{{K}_{t}^{2}} \frac{DOC}{t} ( dimensionless ) \qquad Equation 28$$

$$\frac{{TA}^{2}}{{tK}_{t}^{2}} \frac{DOC}{t} ( dimensionless ) \qquad Equation 29$$

The evaluation of the above stress profile attributes is less intensive for a flat portion of the glass-based article away from the edges. Furthermore, for 2.5D geometries, the ratio DOC/t in the flat (and thicker) part of the sheet away from the 2.5D edge may not be as critically important as in the case of non-2.5D geometries because of the importance of strengthening the 2.5D edge area. Thus, while all above tension zone stress profile attributes can be applied to improve the fracture resistance of glass-based articles having 2.5D edges, it is likely that in a majority of cases, focusing on the stress profile attributes not explicitly including DOC/t would lead to higher performance in the 2.5D context than focusing on the corresponding stress profile attributes that include DOC/t. Of course, some minimum value of DOC/t may be imposed when maximizing the DOC-free stress profile attributes, to ensure there is no performance degradation due to disregarding the importance of DOC completely.

In embodiments, the DOC of glass-based article may be greater than or equal to 0.150 t, greater than or equal to 0.160 t, greater than or equal to 0.170 t, greater than or equal to 0.180 t, greater than or equal to 0.190 t, or greater than or equal to 0.200 t. In embodiments, the DOC of glass-based article may be greater than or equal to 0.205 t or greater than or equal to 0.210 t.

Another set of tension zone stress profile attributes that more directly relate to the levels of deepest stress in the compression region incorporate the slope of stress profile at the DOC as a high slope at the DOC for a diffusion-produced stress profile signifies high compressive stress in the region of the compressive layer that is nearest the DOC. The slope at DOC may be calculated as follows:

$${{s}_{σ}^{DOC} = \frac{d σ}{dx} \vert}_{x = DOC} \qquad Equation 30$$

and the associated stress profile attributes are:

$$\frac{{TAs}_{σ}^{DOC}}{tPT} \qquad Equation 31$$

$$\frac{{TAs}_{σ}^{DOC}}{BTZ \times PT} ≡ \frac{\overline{{σ}_{t}} {s}_{σ}^{DOC}}{PT} \qquad Equation 32$$

$$\frac{{TAs}_{σ}^{DOC}}{{K}_{t}} \qquad Equation 33$$

$$\frac{{TAs}_{σ}^{DOC}}{{K}_{t} \sqrt{t}} \qquad Equation 34$$

$$\frac{{TAs}_{σ}^{DOC}}{{K}_{t}^{2}} \qquad Equation 35$$

$$\frac{TA \overline{{σ}_{t}}}{{K}_{t}^{2}} {s}_{σ}^{DOC} \qquad Equation 36$$

$$\frac{{TA}^{2}}{{tK}_{t}^{2}} {s}_{σ}^{DOC} \qquad Equation 37$$

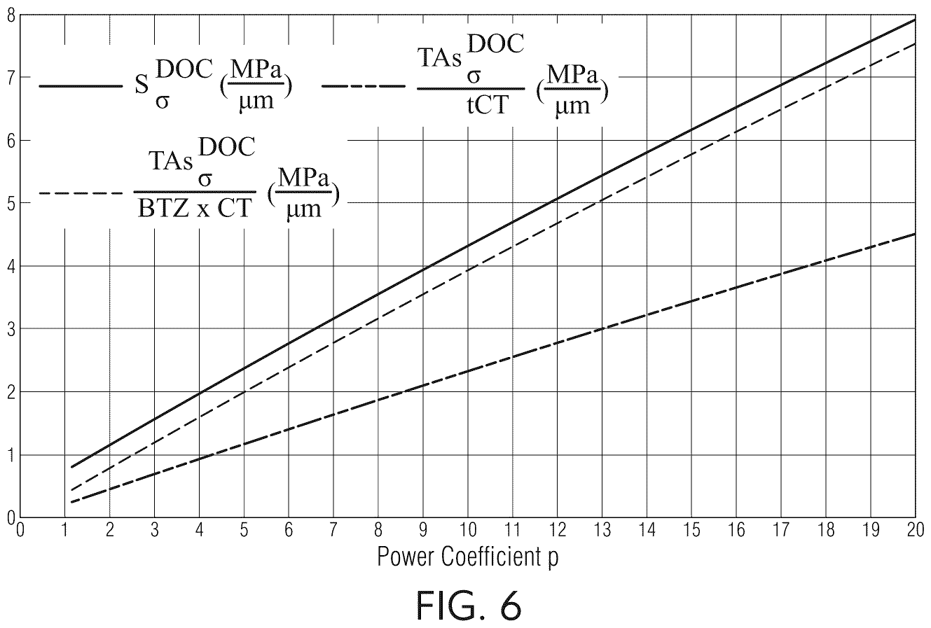

FIG. 6 is a plot showing stress profile attributes s_{σ}^{DOC},

$$\frac{{TAs}_{σ}^{DOC}}{tPT} , and \frac{{TAs}_{σ}^{DOC}}{BTZ \times PT}$$

(y-axis) in terms of power coefficient p (x-axis). FIG. 6 shows how these stress profile attributes show significant rate of increase even when the power coefficient p is high. This significant rate of increase is driven by the growth of the slope-at-DOC, evaluated at the inner side of the tension zone. The continued growth of these stress profile attributes even at high values of p indicates additional significant benefit of high-p profiles for strengthening against deep flaws, with tips close to the DOC but preferably not exceeding the DOC.

Stress profile attributes combining DOC and/or thickness, along with the slope-at-DOC include:

$$DOC \times {s}_{σ}^{DOC} \qquad Equation 38$$

$$t \times {s}_{σ}^{DOC} \qquad Equation 39$$

$$\frac{DOC}{t} {s}_{σ}^{DOC} \qquad Equation 40$$

$$\frac{TA}{PT} \frac{DOC}{t} {s}_{σ}^{DOC} \qquad Equation 41$$

$$\frac{{TAs}_{σ}^{DOC}}{BTZ \times PT} \frac{DOC}{t} ≡ \frac{\overline{{σ}_{t}} {s}_{σ}^{DOC}}{PT} \frac{DOC}{t} \qquad Equation 42$$

In embodiments, DOC×s_{σ}^{DOC} for the glass-based article may be greater than or equal to 140 MPa. In embodiments, DOC×s_{σ}^{DOC} for the glass-based article may be greater than or equal to 160 MPa, greater than or equal to 175 MPa, greater than or equal to 190 MPa, greater than or equal to 200 MPa, greater than or equal to 210 MPa, greater than or equal to 220 MPa, greater than or equal to 230 MPa, greater than or equal to 240 MPa, greater than or equal to 250 MPa, greater than or equal to 260 MPa, or greater than or equal to 265 MPa. In embodiments, the surface compressive stress CS may be greater than or equal to 100 MPa or greater than or equal to 110 MPa. In embodiments, the surface compressive stress CS may be less than or equal to 1.1DOC×s_{σ}^{DOC}, less than or equal to 1.0DOC×s_{σ}^{DOC}, or less than or equal to 0.9DOC×s_{σ}^{DOC} High value for the stress profile attributes above are indicative of glass-based articles having high compressive stress levels deep into the compressive stress layers. In embodiments, the surface compressive stress CS may be greater than or equal to 500 MPa, greater than or equal to 550 MPa, greater than or equal to 600 MPa, greater than or equal to 650 MPa, greater than or equal to 675 MPa, greater than or equal to 700 MPa, greater than or equal to 725 MPa, greater than or equal to 750 MPa, greater than or equal to 775 MPa, or greater than or equal to 800 MPa.

In embodiments wherein the glass-based article comprises a compressive spike at the surface, the knee compressive stress CSₖ (the value of compressive stress that the deeper portion of the CS profile extrapolates to at the depth of spike (DOL_{SP})), may be greater than or equal to 100 MPa or greater than or equal to 110 MPa. In embodiments, wherein the glass-based article comprises a compressive spike at the surface, the knee compressive stress CSₖ may be less than or equal to 1.1(DOC−DOL_{SP})×s_{σ}^{DOC}, less than or equal to 1.0(DOC−DOL_{SP})×s_{σ}^{DOC}, or less than or equal to 0.9(DOC−DOL_{SP})×s_{σ}^{DOC}.

In embodiments wherein the glass-based article comprises a compressive spike at the surface, the depth of spike DOL_{SP} may be greater than or equal to zero and less than or equal to an upper limit DOLᵤₗ, wherein DOLᵤₗ is the larger of 4 μm and 0.01 t.

In embodiments wherein the glass-based article comprises a compressive spike at the surface, a portion of the stress profile between DOL_{SP} and DOC may comprise a negative curvature. One of the paths to obtaining very high ratios of DOC/t (such as above 0.19 and 0.20) while simultaneously having high values of p and

$$\frac{TA}{BTZ \times PT}$$

is through the utilization of negative curvature in a sub-region of the compressive-stress region occurring somewhere between the knee point (DOL_{SP}) and the DOC, together with limiting the length of diffusion to prevent substantial enrichment at the mid-plane in Na₂O. When such negative curvature in the compressive stress profile occurs at depths slightly beyond the spike depth (i.e., towards the center of the glass specimen), e.g., by just a few microns and substantially distanced from the DOC, particularly in the depth region below about 50-60 um from the surface, the finite resolution of the SLP-2000 measurement, and the distortion of retardation by the effects of surface scattering and convolution, make it complicated to ascertain the existence of negative curvature from the SLP-2000 measurement alone. On the other hand, some stress profiles can be proven to contain negative compressive stress curvature based on combining the accurate measuring of the tension zone boundaries and the slope of the stress profile at the DOC with an evanescent prism-coupling (EPC)-measurement (e.g., FSM-6000) of the knee stress CSₖ. Taking into account that the value CSₖ occurs approximately at the depth of the spike DOL_{SP}, if the compressive stress profile in the compression region beyond the spike depth were a straight line to the DOC with second derivative equal to zero of the that entire depth span, then the following equality holds: CSₖ−s_{σ}^{DOC}×(DOC−DOL_{SP}).

From here, it should be obvious that if CSₖ<s_{σ}^{DOC}×(DOC−DOL_{SP}), then there must be a sub-region between the DOL_{SP} and DOC where the slope of compressive stress profile is smaller than the slope at DOC by absolute value, which means that with increasing depth, the slope of the compressive stress profile becomes more negative (higher absolute value) as the DOC is approached. If the slope (i.e., first derivative) of the compressive stress profile is turning more negative as the DOC is approached, this means that at those points where it is turning more negative, its second derivative is negative, as is its curvature (the curvature is proportional to the second derivative, and the coefficient of proportionality is always positive).

Furthermore, since for the cases of interest in this disclosure the condition DOL_{SP}<<DOC holds, it follows that the condition CSₖ<s_{σ}^{DOC}×DOC will tend to indicate with presence of a sub-region of negative second derivative of the compressive stress profile in the region between DOL_{SP} and DOC. Further, it should be noted that in reality there is a small transition region around the depth DOL_{SP} where the compressive stress has strong positive second derivative associated with transitioning of compressive stress from high negative slope in the spike to a much smaller slope, negative or otherwise, immediately following the spike. The CSₖ value detected by prism-coupling, when both the TM and TE total-internal reflection (TIR) transitions are in the preferred measurement window, tends to correspond to a point on the compressive stress profile that occurs in that small transition region of strong positive second derivative, and thus the measured CSₖ value tends to be somewhat higher than what would be directly extrapolated from the slope (first derivative) of the deeper sub-region immediately following the transition region. In other words, if the profile is strictly a straight line from slightly deeper than DOL_{SP} to DOC, the measured value of CSₖ will tend to be somewhat higher than s_{σ}^{DOC}×(DOC−DOL_{SP}). Thus, it would be possible, even common, to have cases having only small negative second derivative at depths slightly exceeding DOL_{SP} and also having measured CSₖ value that is very slightly higher than s_{σ}^{DOC}×(DOC−DOL_{SP}) if most of the deeper compressive stress region is essentially a straight line. On the other hand, it would be substantially less likely that the compressive stress region between DOL_{SP} and DOC contains a sub-region of negative second derivative of compressive stress if CSₖ is substantially higher than s_{σ}^{DOC}×(DOC−DOL_{SP}). To summarize, having CSₖ similar or smaller than s₆DC×(DOC−DOL_{SP}), indicates that the compressive stress profile beyond DOL_{SP} contains a sub-region of negative second derivative, and guarantees that the compressive stress distribution is not heavily weighed closer to the surface, but rather has substantial compressive stress at larger depths. This is more so when the measured value of CSₖ is substantially below s_{σ}^{DOC}×(DOC−DOL_{SP}), for example being at least below 0.9s_{σ}^{DOC}×(DOC−DOL_{SP}).

Higher CSₖ is strongly associated with higher fracture resistance during system drop testing on a rough surface (such as sandpaper), at least when DOC is nearly maximized already. The inventive stress profiles in the present disclosure tend to feature high levels of CSₖ, which is to a large extent is associated with the high slope at DOC resulting from the targeting of a preferred shape in the central tension zone. At the same time, particularly preferred inventive profiles are those that also satisfy CSₖ≤1.1DOC×s_{σ}^{DOC}, and further better CSₖ≤DOC×s_{σ}^{DOC}, or CSₖ−<s_{σ}^{DOC}×(DOC−DOL_{SP}), and especially CSₖ≤0.9s_{σ}^{DOC}×(DOC−DOL_{SP}), to ensure that a significant portion of the compressive stress area is disposed at larger depths of the profile, since retained strength for deeper flaws is more significantly and positively impacted by larger amounts of compressive stress at such larger depths. At the same time, to ensure that CSₖ is high, preferred embodiments also have a DOC×s_{σ}^{DOC} that is relatively high, such as higher than 140 MPa, preferably higher than 170 MPa, and especially preferably higher than 190 MPa (the higher, the better, as long as DOC is adequate to encompass the majority of flaws expected to occur during service).

In embodiments, t×s_{σ}^{DOC} for the glass-based article may be greater than or equal to 700 MPa, greater than or equal to 800 MPa, greater than or equal to 850 MPa, greater than or equal to 900 MPa, greater than or equal to 970 MPa, greater than or equal to 1000 MPa, greater than or equal to 1040 MPa, greater than or equal to 1100 MPa, or greater than or equal to 1120 MPa. In embodiments, the stress profile attribute shown in Equation 40 may be greater than or equal to 0.2 MPa/μm or greater than or equal to 0.3 MPa/μm. In embodiments, the stress profile attribute shown in Equation 40 may be greater than or equal to 0.325 MPa/μm, greater than or equal to 0.350 MPa/μm, greater than or equal to 0.375 MPa/μm, greater than or equal to 0.400 MPa/μm, greater than or equal to 0.425 MPa/μm, greater than or equal to 0.450 MPa/μm, or greater than or equal to 0.475 MPa/μm.

Stress profile attributes explicitly accounting for improved DOC, including ratios of TA to Kₜ or Kₜ and also including the slope-at-DOC include:

$$\frac{{TAs}_{σ}^{DOC}}{{K}_{t}} \frac{DOC}{t} \qquad Equation 43$$

$$\frac{{TAs}_{σ}^{DOC}}{{K}_{t} \sqrt{t}} \frac{DOC}{t} \qquad Equation 44$$

$$\frac{{TAs}_{σ}^{DOC}}{{K}_{t}^{2}} \frac{DOC}{t} \qquad Equation 45$$

$$\frac{TA \overline{{σ}_{t}}}{{K}_{t}^{2}} \frac{DOC}{t} {S}_{σ}^{DOC} \qquad Equation 46$$

$$\frac{{TA}^{2}}{{tK}_{t}^{2}} \frac{DOC}{t} {S}_{σ}^{DOC} \qquad Equation 47$$

The stress profile attributes TA/tPT (Equation 15),

$$\frac{TA}{BTZ \times PT} ≡ \frac{\overline{{σ}_{t}}}{PT}$$

### (Equation 16), TA/PT DOC/t (Equation 23),

$$\frac{TA}{BTZ \times PT} \frac{DOC}{t} ≡ \frac{\overline{{σ}_{t}}}{PT} \frac{DOC}{t}$$

(Equation 24), TAs_{σ}^{DOC}/tPT (Equation 30),

$$\frac{{TAs}_{σ}^{DOC}}{BTZ \times PT} ≡ \frac{\overline{{σ}_{t}} {s}_{σ}^{DOC}}{PT}$$

### (Equation 31),

$$\frac{{TAs}_{σ}^{DOC}}{BTZ \times PT} \frac{DOC}{t} ≡ \frac{\overline{{σ}_{t}} {s}_{σ}^{DOC}}{PT} \frac{DOC}{t}$$

### (Equation 41), and

$$\frac{TA}{PT} \frac{DOC}{t} {S}_{σ}^{DOC}$$

(Equation 42), which do not contain Kₜ or Kₜ², are particularly convenient for accurate measurements using scattered-light photoelastic (SLP) technology due to being substantially insensitive to moderate calibration errors. This is because calibration errors tend to cancel in the ratios TA/PT, and because each of the variables in the stress profile attributes are directly measurable from the retardance curve obtained from the SLP measurement, apart from the thickness which is also easily measurable separately with very high precision using a micrometer. In fact, an independent direct measurement of the thickness using a micrometer can be used to verify the depth calibration of the SLP measurement and thus ensure the accuracy of other terms such as DOC/t, BTZ, σ̅ₜ, and s_{σ}^{DOC}. The retardance curve is a plot showing the retardance between transverse magnetic (TM) and transverse electric (TE) polarized light as a function of depth of the laser beam as it passes through the specimen thickness in an SLP measurement. The retardance may be measured directly by viewing points along the laser beam with a camera, and the curve is obtained by mapping these points against depth and plotting the retardance against depth.

Specifically, the parameters of the stress profile attributes can be obtained directly form the retardance curve as follows:
TA is proportional to the difference between the highest and lowest values of retardance in the retardance curve, e.g., the difference in retardance between the two points where the stress profile crosses zero.
PT is proportional to the maximum slope of the retardance curve between the locations of minimum and maximum retardance.
BTZ is the depth difference between the points of minimum and maximum retardance.
DOC is the distance from the surface to the nearest minimum or maximum of retardance.
s_{σ}^{DOC} is proportional the second derivative of the retardance at the location of maximum retardance

$$( \frac{{d}^{2} Φ}{{dx}^{2}} {\vert}_{{Φ}_{max}} )$$

or minimum retardance

$$( \frac{{d}^{2} Φ}{{dx}^{2}} {\vert}_{{Φ}_{min}} )$$

(which locations coincides with the locations of zero-crossing of the stress profile).

While TA, PT, and s_{σ}^{DOC} do depend on the calibration of the instrument, the stress profile attributes TA/tPT (Equation 15),

$$\frac{TA}{BTZ \times PT} ≡ \frac{\overline{{σ}_{t}}}{PT}$$

### (Equation 16), TA/PT DOC/t (Equation 23), and

$$\frac{TA}{BTZ \times PT} \frac{DOC}{t} ≡ \frac{\overline{{σ}_{t}}}{PT} \frac{DOC}{t}$$

(Equation 24) do not depend on the calibration and are thus insensitive to moderate calibration errors. In particular,

$$\frac{TA}{PT} = \frac{{Φ}_{max} - {Φ}_{min}}{{( \frac{d Φ}{dx} )}_{max}} \qquad Equation 48$$

where Φ(x) is the measured retardance in radians, degrees, or nanometers as a function of the depth x.

$$\frac{\overline{{σ}_{t}}}{PT} ≡ \frac{TA}{BTZ \times PT} = \frac{{Φ}_{max} - {Φ}_{min}}{\vert x ( {Φ}_{max} ) - x ( {Φ}_{min} ) \vert {( \frac{d Φ}{dx} )}_{max}} and \qquad Equation 49$$

$$\overline{{σ}_{t}} ≡ \frac{TA}{BTZ} = \frac{{Φ}_{max} - {Φ}_{min}}{\vert x ( {Φ}_{max} ) - x ( {Φ}_{min} ) \vert} \qquad Equation 50$$

Experimental retardance curves often contain noise, which may increase the uncertainty of the measured quantities, especially those involving derivatives of the retardance (such as PT and s_{σ}^{DOC}). Hence, it is strongly preferred to use SLP equipment having a shorter wavelength (violet) and noise-reduction means (such as laser-speckle suppression), to start with a relatively good signal-to-noise ratio. Furthermore, if noise still makes the uncertainty of the measured quantities higher than a few %, then fitting of the retardation curve or portions of it should be applied to get more precise estimates of Φₘₐₓ, Φₘᵢₙ,

$${( \frac{d Φ}{dx} )}_{max} , and \frac{{d}^{2} Φ}{{dx}^{2}} {\vert}_{{Φ}_{max}} or \frac{{d}^{2} Φ}{{dx}^{2}} {\vert}_{{Φ}_{min}} .$$

Finally, as discussed above with regards to commercial-grade SLP equipment, it may be necessary to conduct several measurements, e.g., ten measurements, and to average the retardance data for subsequent analysis and extraction of various attributes of interest.

### SLP-2000 Stress Profile Characterization Method

In accordance with the discussion above, stress profile attributes of embodiments described herein may be measured using a SLP-2000 Stress Profile Characterization Method. The SLP-2000 Stress Profile Characterization Method utilizes the commercial SLP-2000 manufactured by Orihara Industrial Co., Ltd., using an operating light source (laser) wavelength of 405 nm. To address the laser-speckle noise in the spatial distribution of optical intensity in the images of the laser beam, which, by default, may be too high to allow for precise determination of essential profile-shape aspects with a single measurement, the SLP-2000 Stress Profile Characterization Method involves performing ten measurements wherein the glass specimen is either rotated or linearly shifted between each measurement. Each of the ten measurements produces a different speckle-noise pattern which drives a different retardation-noise pattern on the retardation curve. After all ten measurements are completed and the retardation curves saved, an average retardation curve is obtained, featuring significantly reduced noise relative to the retardation noise of the individual retardation curves.

If the glass specimen is rotated between each measurement, different retardation noise patterns can be achieved by covering a cumulative angular range of rotation of 180 degrees with approximately equal angular spacing between the consecutive orientations, e.g., approximately 20 degrees per rotation. However, a greater cumulative angular range of rotation and/or different rotation increments may be implemented provided that multiple measurements do not occur at exactly the same specimen position and orientation, which could result in identical noise patterns that persist even after averaging. If the glass specimen is linearly shifted between each measurement, it should be shifted by about 100 μm (approximately the diameter of the 405 nm laser) between each measurement such that the ten measurements involve a cumulative linear shift of about 1 mm. However, as with the specimen rotation method, a greater cumulative linear shift and/or different linear shift increments may be implemented provided multiple measurements do not occur at exactly the same specimen position and orientation.

To ensure the accuracy of the measured retardation curves, the SLP-2000 should be calibrated in accordance with the manufacturer-provided calibration procedure. This involves providing the SLP-2000 software with accurate values for the prism index (provided by manufacturer) and the measured-glass index at the measurement wavelength, as well as an accurate value for the stress optical coefficient (SOC) of the measured glass at the measurement wavelength. It is also important, when using the manufacturer-provided depth calibration specimen (“depth standard glass”) and stress calibration specimen (“stress standard glass”), to supply the SLP-2000 software with correct calibration coefficients for each calibration specimen at the measurement wavelength. There are three calibration coefficients provided in the 2018 version of the SLP-2000 software, one for depth correction (“DOL_zero”) and two for stress correction, surface stress correction and deep stress correction (“CS correction” and “deep stress correction,” respectively). For the retardation curve in the central tension zone to give an accurate representation of the depth integral of the stress profile in the tension zone, the deep stress correction calibration coefficient needs to be equal or approximately equal to the surface stress correction calibration coefficient. Otherwise, the stress profile would get distorted by the application of the deep stress correction calibration coefficient. It is also the case that when the deep stress correction calibration coefficient is not set to the same value as surface stress correction calibration coefficient, the shape of the resulting stress profile changes depending on the depth to which the deep stress correction refers (the deep stress correction value is supposed to be applied to a particular depth). Thus, it is best to keep the deep stress correction calibration coefficient the same as the surface stress correction calibration coefficient (i.e., “deep stress correction”=“CS correction”) to avoid unexpected distortions of the profile.

For the SLP-2000 instrument used by the present inventors, performing depth calibration using the depth calibration specimen resulted in a depth correction coefficient very close to 1, usually between 0.99 and 1.0, so the present inventors kept the value of the depth correction coefficient at 1. The surface compressive stress calibration, applied multiple times over many days, had average values ranging from about 1.038 to about 1.048. Each of these calibration values was obtained after measuring the calibration specimen 10 times, and obtaining an average of the 10 surface compressive stress values to represent the calibration measurement value. The present inventors set the surface stress correction calibration coefficient at 1.04. Furthermore, since the retardation curve was resulting in a relatively symmetric stress profile, the deep stress correction calibration coefficient was set to the same value as the surface stress correction calibration coefficient.

The SLP-2000 Stress Profile Characterization Method described herein permits accurate and reproducible measurements of an averaged retardation curve for a glass specimen, which is subject to post-processing procedures described below to extract attributes of the corresponding stress profile of the glass specimen. Thus, in addition to the above-described measurement technique and calibration procedure, the SLP-2000 Stress Profile Characterization Method involves the following post-processing procedures to extract attributes of the corresponding stress profile of the glass specimen.

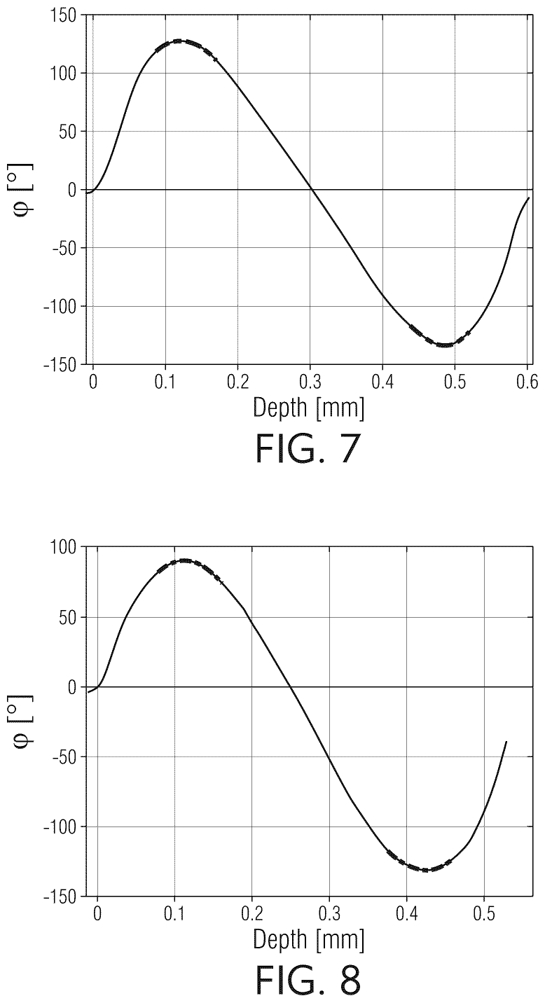

FIG. 7 presents an average retardation curve for Example 7 and is referred to below to facilitate discussion of the post-processing procedures utilized by the SLP-2000 Stress Profile Characterization Method. The horizontal axis of FIG. 7 represents a spatial coordinate along the depth dimension to the glass specimen, and is approximately equal to the depth measured from the surface within the accuracy of identifying the precise location of the glass specimen surface on the retardation curve (typically comparable to the DOC-precision specification of ±5 μm). The vertical axis shows the measured retardation (phase-difference) between the transverse-electric and the transverse-magnetic polarization states, in degrees. The continuous line represents said average retardation of the ten measurements. The two dashed lines, one near a local peak of the retardation, another near a local trough, represent local 4^{th}-order polynomial fits, which are used to determine a more precise location of the peak and trough of the retardation with sub-pixel resolution. The 4^{th}-order polynomial fits are based on retardance data spanning between 32 microns on the outside (i.e., in the corresponding compressive stress layer) and 51 microns on the inside (i.e., in the central tension region). The location of the peak and the trough were obtained from the local minimum/local maximum of the corresponding 4^{th}-order local polynomial fits, evaluated on a dense depth grid with depth spacing of 0.05 microns.

The obtained x-coordinates, or x-positions of the maximum and the minimum of the retardation curve, represent the locations where stress changes sign, e.g., from compressive stress to tensile stress, or vice-versa. When measured with respect to the nearest surface of the specimen, these locations represent the corresponding depths of compression (DOCs) relative to said nearest surfaces. The breadth of tension zone BTZ is determined as the difference between the x-positions corresponding to the maximum (peak) and the minimum (trough) of the retardation curve.

It should be noted that if the incidence angle of the laser beam inside the specimen, measured relative to the orientation normal to the specimen large surfaces, is greater than about 80 degrees, then there may be a small deviation between the locations of the peak and trough of the retardation curve, and the locations where stress changes sign. Thus, at very high beam angle, especially substantially above 80 degrees, effects of slightly different beam bending for transverse-electric and transverse-magnetic waves may lead to the need of more complicated analysis to keep the accuracy of measurement of the stress profile high (See Siim Hodemann et al., “Gradient scattered light method for non-destructive stress profile determination in chemically strengthened glass”, J. Mater. Sci., 51: 5962-5978 (2016)).

The peak tension PT is determined by fitting each of the ten individual retardation curves with the 6^{th}-order polynomial fit provided in the SLP-2000 software, restricting the region of fitting to the interior of the glass specimen, excluding the outermost 70-80 micrometers on either side of the glass specimen. The peak tension PT for each measurement is determined by calculating the maximum slope of the 6^{th}-order polynomial fit between the locations of minimum and maximum retardance. It was determined that despite the relatively high retardation noise in individual measurements, averaging the peak tension PT of the ten measurements with different specimen orientations produced a value that was nearly identical to the peak tension PT that is obtained after averaging the retardation data for the ten retardation curves and then performing a 6^{th}-order fit on the averaged retardation curve to calculate the peak tension PT. Hence, for the purposes of determining the peak tension PT of the stress profile, it is adequate to average the peak tension PT of ten measurements with slightly different orientations or positions, as explained above, taking advantage of the 6 t-order polynomial fit utility in the SLP-2000 software.

Next, the averaged retardation curve is decomposed into symmetric and anti-symmetric components, where the plane of decomposition (plane of symmetry) is chosen as the mid-point between the locations of the peak and the trough of the retardation curve (see FIG. 7). When a symmetric stress model is used to obtain a retardation model for fitting the retardation curve, that retardation model will produce anti-symmetric retardation with respect to a through-thickness axis centered at said mid-point or mid-plane (centered at that point/plane means that the zero-value of the axis is located at the mid-plane). This decomposition is performed because even after performing the above-described averaging of individual retardation curves to mitigate the noise in the retardation data, obtaining a precise fit to the improved retardation can still be limited by certain distortions in the retardation curve that may be caused by systematic error of the measurement setup, asymmetry in the actual stress profile, and/or some warp in the glass specimen. For more information regarding the decomposition of the retardation curve, see U.S. Pat. No. 11,105,561, issued Aug. 31, 2021, entitled “Hybrid Systems and Methods for Characterizing Stress in Chemically Strengthened Transparent Substrates,” the entirety of which is incorporated herein by reference (see col. 32, lines 33-67).

Next, nonlinear fitting of the anti-symmetric component of the averaged retardance curve is performed based on an integral form of the power model provided in Equation 14, using the breadth of tension zone BTZ and the peak tension PT as model input parameters and restricting the region of fitting to a sub-region in the interior of the glass specimen. The sub-region contains the entire tension zone, and excludes at least the outermost 50 microns on either side of the specimen, as it is well understood that the retardation in the outermost 50 microns is not a straightforwardly accurate representation of a depth integral of the stress profile due to various effects of distortion that are beyond the scope of the present discussion. Furthermore, depending on the scattering intensity of the specimen-prism interfacing oil (liquid, fluid), the specimen-back-cover-interfacing oil, and the index mismatch between oil and glass, oil and prism, and the surface roughness of the glass specimen and the prism, the focusing condition of the beam, the rate of change of stress with depth, the rate of change of stress slope with depth, and the thickness of the specimen, some non-negligible degree of difference is present between the retardation in depth range 50-110 microns and a hypothetical perfect retardation that would have been exactly proportional to the depth integral of stress to a corresponding depth in that range. The difference (or error) typically diminishes with increasing depth, and is most often small enough by a depth of 110 microns unless the surface roughness is very significant and causes very bright surface scattering, corrupting the retardation signal corresponding to relatively large depths. Fitting the retardation signal at depths significantly smaller than the compression depth does not improve the accuracy with which the fit represents the retardation of the tension region. Thus, ensuring an accurate measurement of important aspects of the tension-zone stress profile such as the shape, preferably relies on fitting over the tension zone and only a small portion of the compression zone, nearest to the depth of compression. To get a more precise value for the slope at DOC, the fitting region extends at least 15 microns into the compression stress layers on either side of the central tension zone.

The anti-symmetric integral of the symmetric-stress power-profile model that is used to fit the anti-symmetric component of the experimental retardation curve is given in terms of the optimization parameters b₁ and b₂ in the form:

$$I ( {b}_{1} , {b}_{2} , x ) = {b}_{1} ⋆ z ⋆ \frac{{( 1 - \vert \frac{2 z}{BTZ} \vert )}^{{b}_{2}}}{{b}_{2} + 1}$$

where the optimization parameters b₁ and b₂ correspond to the slope of retardation generated by the center tension, and the profile-shape parameter p, and the coordinate z corresponds to the through-thickness coordinate, representing signed distance from the mid-plane between the peak and trough of the retardation, being positive on one side of the plane and negative on the other.

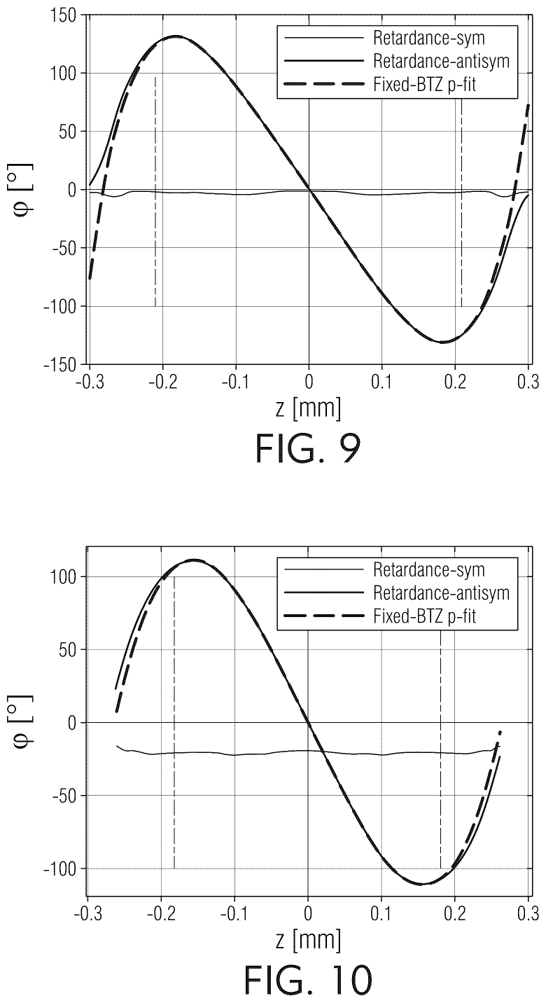

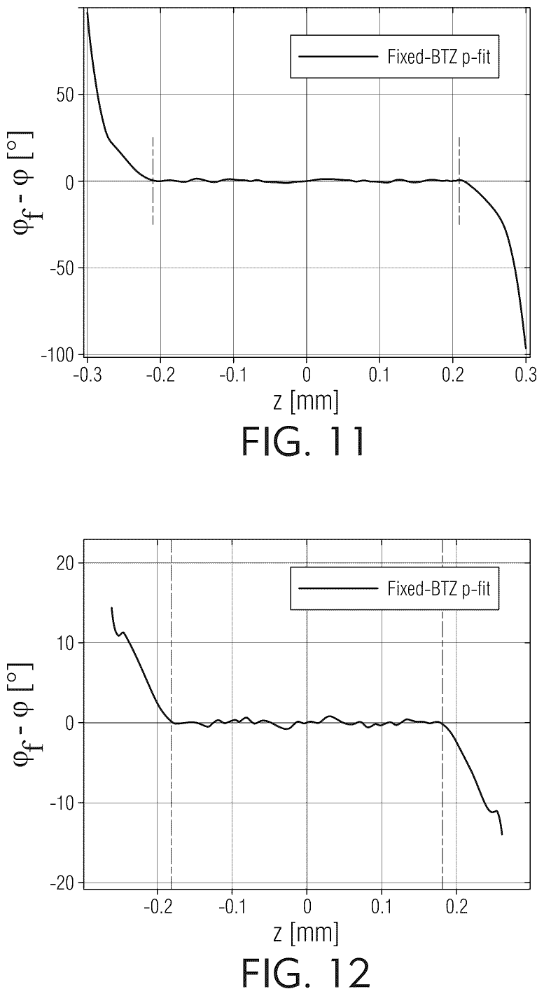

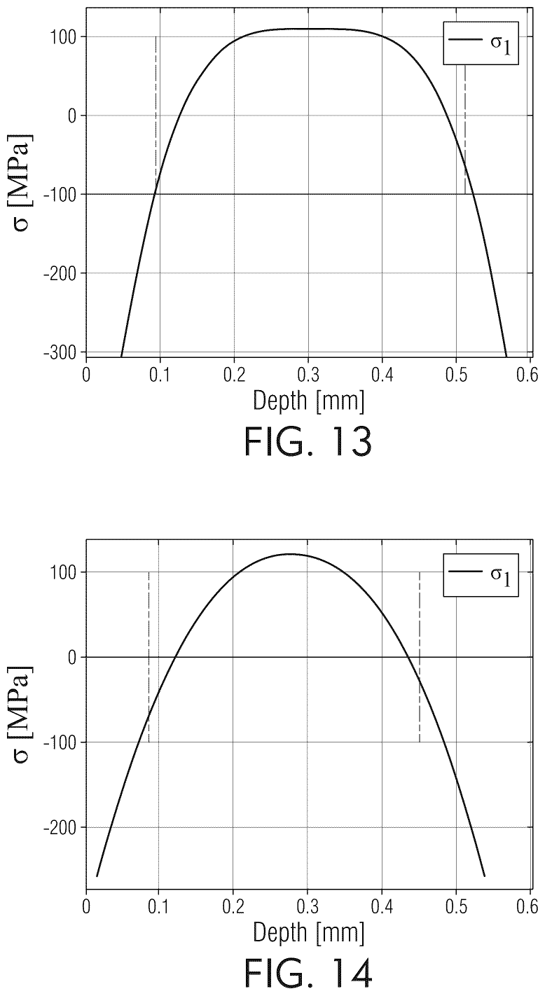

The nonlinear fitting routine used along with the power model of tensile-zone stress was the function ‘nlinfit’ available in Matlab and Octave software engines for scientific numerical computations. FIG. 9 shows the integrated power-profile model of Equation 14 fitted to the anti-symmetric component of the averaged retardance curve for Example 7, wherein the vertical dashed lines indicate the boundaries of the fitted region. FIG. 11 shows the residuals between the anti-symmetric component of the averaged retardation and the fitted power-profile model of the same, wherein the residuals do not exceed 1.5 degrees by absolute value. It can be seen from FIGS. 9 and 11 that the power profile provided in Equation 14 accurately represents the stress profile in central tension zone of the chemically strengthened glass-based articles of the present disclosure. The associated stress profile of the fitted power model for Example 7 is shown in FIG. 13, wherein the vertical dashed lines indicate the boundaries of the fitted region. The fitted power model is then used to determine the tension area TA, slope at DOC s_{σ}^{DOC}, and the frangibility factor Kₜ.

The thickness of the glass specimens is measured by a micrometer. For stress profiles that are symmetric about the center plane of the glass specimen, DOC₁ and DOC₂ are assumed to be equal (DOC₁=DOC₂=DOC) and DOC is determined by subtracting the breadth of tension zone BTZ from the thickness and dividing by 2, using a micrometer to measure the thickness of the glass specimen. However, for substantially asymmetric stress profiles, DOC₁ and DOC₂ may be determined using the SLP-2000 data.

### Compressive Stress Layer Characterization Method

As described hereinabove, stress profile attributes of the compressive stress layers of embodiments described herein may be measured using a prism-coupling instrument similar to FSM-6000, but with additional options for the operating wavelength that provides for a preferred measurement window, as described in U.S. Pat. No. 11,448,595, issued Sep. 20, 2022, entitled “Prism-Coupling Systems and Methods with Improved Intensity Transition Position Detection and Tilt Compensation,” the entirety of which is incorporated herein by reference. The Compressive Stress Layer Characterization Method of the present disclosure is performed in accordance with U.S. Pat. Nos. 11,448,595 and 11,703,500, issued Jul. 18, 2023, entitled “Methods of characterizing ion-exchanged chemically strengthened glasses containing lithium,” the entirety of which is incorporated herein by reference. This approach allows for the measurement of the compressive knee stress CSₖ, the depth of spike DOL_{SP}, and the surface compressive stress CS. In performing the CSₖ measurements, the wavelength must be chosen such that there is no resonance close to the TIR transition for both the TE and the TM polarization.

The surface compressive stress CS is obtained using the spectrum of fringes at 365 nm, and utilizing the extrapolation of surface index based on the assumption that the index profile in the spike is linear from the surface to the depth (turning point) of the second mode (fringe). In this approximation, the surface index equals the effective index of the first mode plus 1.317 times the effective-index spacing of the first and second mode.

The present disclosure introduces above a number of stress profile attributes which are helpful in characterizing the nature of stress profiles imparted via ion-exchange treatment(s). Without wishing to be bound by theory, it is believed that the stress profile attributes described herein and related limits and ranges will result in glass-based articles exhibiting improved fracture resistance while avoiding frangibility. The following portion of the present disclosure provides exemplary ion-exchange treatment methods that may be utilized to achieve the desired stress profile attributes described herein. Following the exemplary ion-exchange treatment methods are examples of chemically strengthened glass-based articles of the present disclosure.

### Exemplary Ion-Exchange Methods:

### For Na-Based Glasses:

First approach: Ion exchange in a potassium-ion-rich bath, such that the surface concentration of K₂O in the glass is increased by at least 5 mol %, preferably by more or significantly more. Ion exchange until the target DOC/t ratio is approached. Choose the surface concentration such that the glass reaches close to the frangibility limit when the DOC/t ratio is approached. Then perform a moderate heat treatment which increases the DOC further and slightly decreases the tension-strain energy on account of the increased DOC and decreasing uniformity in the tension zone. Then, perform a short spike step in a K-rich bath to finish off the profile with high surface CS, if needed.

Second approach: (for further higher p and higher slope at DOC): Ion exchange in K-rich bath to increase surface concentration of K₂O by more than 5 mol %, preferably significantly more. Ion exchange until the target ratio DOC/t is approached, and allow the glass to enter frangible space, but with extra care to avoid fracture of parts during the chemical strengthening. Then perform a moderate heat treatment to increase the DOC to the target, which will reduce the power coefficient p somewhat and decrease the slope at DOC slightly. If buried peak is preferred, it is okay to follow the heat treatment with a short ion-exchange in a bath having a mixture of Na and K ions such that the surface concentration of K₂O would decrease to result in a buried peak. In some cases it would be acceptable to omit the heat-treatment step prior to such a K₂O-reducing ion-exchange step. After any such combination of heat treatment and a K-lowering step, the glass-based article should be in a non-frangible state. Finally, if a surface spike is desired, perform a short ion exchange in a K-rich bath to increase surface concentration and surface CS. The size of the spike needs to be accommodated by the tension-energy budget, to avoid frangibility.

Third approach: Ion exchange at high temperature in a first K-rich bath. The temperature is high enough to enable strong stress relaxation. In this way, the deepening of the profile is prevented from raising its tension energy to the frangibility limit, at least while the DOC has not reached very close to the target. Then, optionally, perform a short-to-moderate heat treatment to push the DOC further to reach the target DOC. Then perform a short ion exchange in a second K-rich bath to increase surface concentration and surface CS. The heat-treatment step may be unnecessary if the first K-rich bath provides a substantially lower K₂O concentration increase in the surface when compared to the second K-rich bath. The choice of using a heat-treatment step depends on the target of maximum optimization of the profile.

For Li₂O-Containing Glasses Having Relatively High Li₂O Content (for Example, Over 7 Mol % Li₂O, but Preferably More than 8 or 9 Mol % Li₂O):

First approach: Ion exchange at high enough temperature to activate significant stress relaxation in the compression region in a glass with high Li₂O content (greater than 8 mol %, preferably). When the fracture toughness of the glass-based substrate is relatively high and a somewhat limited surface stress is needed to prevent overstress failures of shallow flaws, a single-step ion exchange can be used in a mixed bath (KNO₃ and NaNO₃). Stop ion exchange when DOC is adequate. The temperature is chosen such that stress relaxation is just enough to boost the DOC while the tension-zone uniformity is not degraded yet (e.g., while p is still higher than 2.4, for example), but not so high as to lower the tension energy unnecessarily far below the frangibility limit. An appropriate ion exchange bath for a 0.55 mm thick glass-based substrate having Composition 1 (see Table 1) may contain 8-9.5 wt % NaNO₃, 90.5-92 wt % KNO₃. The glass-based substrate should be properly pre-heated prior to ion exchange and the ion exchange should occur at about 470° C. for about 2.5 to 2.75 hours. This ion exchange procedure will produce a stress profile having a DOC similar to that which would be produced using a 0.7 wt % LiNO₃/9 wt % NaNO₃/90.3 wt % KNO₃ bath composition with a bath temperature of 450° C. and a treatment time of 5 hours. If glass comes out somewhat frangible, a small amount of LiNO₃ may be added to the bath (0.1 to 0.3 wt %) to reduce the TSE. The final profile will have higher stress area than the process-of-record condition when non-frangible. Progressively higher enhancement of the stress profile attributes discussed above can be obtained by further increasing the IOX temperature, shortening the treatment time, and slightly increasing the NaNO₃ content of the bath at the expense of KNO₃ and LiNO₃. For example, it may be advantageous to use an IOX temperature of 480° C. and a treatment time of 2.05 to 2.25 hours, with a bath having 9-11 wt % NaNO₃, less than 0.3 wt % LiNO₃, and the balance KNO₃, for a 0.55 mm thick glass-based substrate having Composition 1. At 490° C., the appropriate time would be 1.7 to 1.87 hours, and the NaNO₃ content of the bath may need to be increased slightly further.

The first approach based on activating an appropriate amount of stress relaxation, increasing NaNO₃ content of the bath, and reducing the treatment time may work adequately for some glasses having composition similar to Composition 1, which has a high content of Li₂O (10.7 mol %) and nonlinear diffusion properties well-suited for allowing profiles of very high PT and DOC. However, this approach may have limited utility for glasses which have lower levels of Li₂O (about 8 mol %), and a more modest ratio Li₂O/Na₂O which is not as favorable for achieving very high PT and very high DOC.

Second approach: A second approach is to utilize a multi-step ion exchange process, wherein the first step provides a Na₂O composition near the surface so as to allow the glass to go frangible in the first ion exchange step when the DOC approaches close to the target DOC. Then, in a second step, the surface spike is formed with KNO₃, wherein the influx of Na ions is strongly or completely suppressed in the second step, or even reversed (by adding appropriate amount of Li ions in the second-step bath). Hence, in the second step, the TSE of the profile is reduced (in most cases along with the PT), while the DOC is slightly increased, and the knee-stress CSₖ is very significantly reduced. The second step is sufficiently short such that the slope at the DOC decreases only slightly relative to that after the first step. An optional brief heat-treatment step may be inserted between the first and second step as long as the heat-treatment step is small enough to avoid significantly reducing the slope at the DOC and decreasing the p-parameter of the profile (e.g., decreasing significantly the uniformity of tension in the tension zone).

Third approach: This approach involves a dual-stage ion exchange process with enhanced stress relaxation in the first stage. In this case, the stage one IOX temperature is increased so much as to activate significant stress relaxation (e.g., somewhere between 100° C. and 20° C. below the glass strain point). The first stage ion exchange is performed until the DOC approaches the target DOC (but not quite reaches it). After the first stage the glass is either somewhat above the frangibility limit, or very close to it. The second stage provides little or no influx of Na ions into the glass, and mainly forms the spike. If necessary, the second stage may extract some Na ions from the glass by supplying the bath with an appropriate relatively low level of Li ions that will exchange with Na ions. The vast majority of cations in the second stage bath, as in the second approach above, are K-ions. For glasses which have lower levels of Li₂O (about 8 mol %) and comparable molar concentrations of Li₂O and Na₂O in the substrate glass, performing the first stage at higher temperature may allow concentration distributions enabling higher DOC due to mitigating some undesirable aspects of nonlinear diffusion.

Fourth approach: In the fourth approach, the portion of the process that develops the deep portion of the stress profile that generates the high tension area and high DOC, is split into two steps. The first of the two steps is a short ion exchange at very high temperature, with strong stress relaxation. In this step, the weight gain is kept to less than about 65% of the total weight gain. The rest of the ion exchange (one or two additional steps, depending on the required combination of surface CS, DOC, and CSₖ), is performed at significantly lower temperature, to limit further stress relaxation.

### EXAMPLES

An exemplary composition of a glass-based substrate capable of being chemically strengthened to meet one or more objectives of the present disclosure is provided below in Table 1 and is herein referred to as “Composition 1.”

TABLE 1
Composition 1 and Composition 2 for Glass-
Based Substrate (analyzed mol %)

| | Composition 1 | Composition 2 |
|---|---|---|
| SiO₂ | 58.38 | 70.63 |
| Al₂O₃ | 17.81 | 12.89 |
| B₂O₃ (ICP) | 6.06 | 1.92 |
| MgO | 4.43 | 2.91 |
| CaO | 0.57 | 0 |
| SrO | 0 | 0 |
| ZnO | 0 | 0.89 |
| Li₂O | 10.74 | 8.29 |
| Na₂O | 1.73 | 2.46 |
| K₂O | 0.2 | 0 |
| ZrO₂ | 0 | 0 |
| Y₂O₃ | 0 | 0 |
| Sum | 100 | 100 |

* While not shown in Table 1, Composition 1 comprises about 0.1 mol % SnO₂.

The properties of the glass-based substrate having Composition 1 are shown below in Table 2:

TABLE 2
Properties of Glass-Based Substrate having Composition 1

| | |
|---|---|
| Density (g/cc) | 2.409 |
| CTE (0-300° C.) ppm (fiber) | 5.31 |
| Stain Point (fiber Elongation) | 563 |
| Annealing Point (fiber Elongation) | 607 |
| Softening Point (fiber Elongation) | 812.1 |
| low-T CTE (×10⁻⁶/° C.) (from CTE bar at 500° C. cooling) | 60.3 |
| low-T CTE (×10⁻⁶/° C.) (from CTE bar at 300° C. cooling) | 54.9 |
| low-T CTE (×10⁻⁶/° C.) (from CTE bar at 50° C. cooling) | 46.8 |
| High-T CTE (×10⁻⁶/° C.) | ~250 |
| Strain PT (BBV) (° C.) | 567.4 |
| Annealing PT (BBV) (° C.) | 611.6 |
| Softening PT (PPV) (° C.) | 814.5 |
| Young's modulus (GPa) | 83.2 |
| Shear's modulus (GPa) | 33.6 |
| Poisson's ratio | 0.236 |
| Fracture Toughness (MPa\sqrt{m}) | 0.89 |
| RI @ 589.3 | 1.5241 |
| SOC (546.1 nm) single PT | 2.971 |

The inventive stress profiles of Examples 1-8 of the present disclosure were obtained using a glass-based substrate having Composition 1. The glass-based substrate having Composition 1 was manufactured on a roller manufacturing platform and polished for high surface quality. As such, the fictive temperature of the glass is substantially higher than that of annealed glass of the same composition, but the fictive temperature difference relative to annealed glass is not as high as the fictive temperature difference between a fusion-formed glass sheet and an annealed glass sheet of the same composition. The elevated fictive temperature of the roller-made glass sheet having Composition 1 (relative to annealed glass) is associated with: higher diffusivity for the alkali ions participating in the ion exchange of chemical strengthening; somewhat higher rate of stress relaxation; and somewhat reduced network-dilation coefficient (e.g., reduced expansion and stress generated per unit of ion exchange). Hence, if the approach of implementing the inventive stress profiles described in the present disclosure is to be applied to an annealed version of the glass, or a glass of similar composition made by the float method, it may require moderate adjustments to the IOX procedure such as an increase in the diffusion time to compensate for the smaller diffusivity of annealed glass, and/or an addition of some LiNO₃ to the bath to reduce the center tension of the annealed glass so as to prevent the annealed glass from becoming frangible. If the diffusion time is not increased, then the preferred high DOC may not be achieved in the annealed glass.

An alternative adjustment for annealed and float glass would be to increase the ion exchange temperature by between about 8° C. and 20° C., depending on how large the difference is between the roller-sheet fictive temperature and the annealed-glass fictive temperature. In most cases this approach would require increasing the temperature between about 10° C. and 15° C. The advantage of taking this approach is that it reduces the ion exchange treatment time and brings all stress profile attributes in the right direction to match the roller-glass implementation because (i) stress relaxation accelerates along with the diffusivity at the higher temperature and (ii) the diffusivity of K ions increases more than that of Na ions. Of course, a combination of moderate temperature increase and small amounts of LiNO₃ addition to the bath is also an acceptable way to implement the target profile in annealed glass without making it frangible. In the following description, the specific times and temperatures utilized for the glass-based substrate having Composition 1 were applicable to the roller-glass fictive temperature.

Examples 1-8 in the present disclosure were produced by performing a single-step ion exchange (SIOX) on a glass-based substrate having Composition 1. One key aspect of the SIOX-based implementation is the use of a mixed bath providing both Na ions and K ions, the former being for controlling of the compressive stress profile in the deep portion of the compressive stress layers and the latter being for controlling the compressive stress profile in the spike of the compressive stress layers. Another key aspect of the SIOX-based implementation is a relatively high bath temperature for activating a non-negligible amount of stress relaxation during ion exchange. Further, another key aspect of the SIOX-based implementation is keeping the ion exchange treatment time within a very narrow window that enables high DOC in combination with the stress relaxation, but does not substantially alter the Na concentration in the deepest portion of the specimen around the mid-plane, such that high power coefficient p of the stress profile is achieved despite the high DOC.

With regard to the activation of stress relaxation, the strain point and the anneal point of the glass are relevant, as is the fictive temperature. The strain point of the glass used in the inventive examples in the present disclosure is about 563° C. as measured by the fiber-elongation method of ASTM C336-71(2015), or about 567° C. as estimated through by beam-bending viscosity (BBV) measurements. The annealing point is about 607° C. by fiber elongation and 612° C. by BBV. The inventive examples in the present disclosure used ion exchange temperatures of at least 455° C., and as high as 490° C. It should be noted that further inventive examples could be generated with even higher ion exchange temperatures, wherein the ion exchange time would be shortened further, and the bath would be shifted toward higher Na/K ratio. The resulting profiles would then still feature the inventive combination of properties of the tension zone and the deep compression region, with the main difference being that the surface compressive stress CS would be slightly smaller than in the examples with ion exchange temperatures in the range 455° C. to 490° C.

In embodiments, the ion exchange temperature for implementing the inventive stress profiles should be no less than the temperature corresponding to about 110° C. below the strain point of the glass (measured by the fiber-elongation method of ASTM C336-71(2015)), and preferably no less than the temperature corresponding to about 107° C. below the strain point of the glass. When increased negative curvature in the compression region is particularly desirable, then the ion exchange temperature should be increased significantly, to the range corresponding to 40-90° C. below the strain point, where it should be understood that (i) when the difference relative to the strain point is diminished, the Na/K ratio of the bath needs to be increased to accomplish high integral of compressive stress, and that (ii) the surface compressive stress CS will be reduced. If it is critically important for the application to also have high surface compressive stress CS, then a two-step process may be needed to enable combining higher negative second derivative of the deep portion of the profile with high stress area and high surface stress, all at the same time.

Moreover, using ion exchange temperatures even closer to the strain point, within less than 40° C. from it, can be useful when the target product thickness is substantially smaller, such as from 0.3 to 0.4 mm. Indeed, in some cases it is particularly important to maximize DOC in such thin glass while at the same time achieve as high integral of compressive stress as possible. The short diffusion time needed for small thickness can work very effectively with a high rate of stress relaxation. Usually, thinner glass has higher frangibility in terms of peak tension, so the combination of small thickness and high ion-exchange temperature will usually also require increasing the Na/K ratio in the ion-exchange bath.

In the examples of the present disclosure the ion exchange times were chosen in such a way as to ensure the composition in the center of the glass article was not modified substantially or at all by the ion exchange, while also achieving high DOC, exceeding 19% of the thickness in all cases, exceeding 20% of thickness in most cases, and in some cases exceeding 21% of the thickness. The relatively narrow range of diffusion times achieving this condition is identified through optimization after (i) a target temperature is chosen to activate enough stress relaxation and (ii) the diffusion properties of the glass for alkali ion exchange are determined at the target temperature.

Example 9 of the present disclosure was produced by performing a dual-step ion exchange (DIOX) on a glass-based substrate having Composition 1 made on a rolling manufacturing platform, and having thickness of 0.502 mm after polish and before ion exchange. In step one, the pre-heated specimen is ion exchanged in a bath having 20% NaNO₃ and 80% KNO₃ by weight, with the standard addition of 0.5% silicic acid, at 500° C. for 0.67 hours. Then, in a second step, the specimen is ion exchanged in a bath comprising about 9% NaNO₃ and 91% KNO₃, with the standard addition of 0.5% silicic acid, at 460° C. for 0.8 hours. After this process, the specimen has a center tension of 130.8 MPa, breadth of tension zone about 104 microns or 20.7% of thickness, surface compressive stress CS of 750 MPa, DOL_{SP} of about 4.2 μm, CSₖ of about 256 MPa obtained at 405 nm, tension area about 28.7 MPa*mm, and p-coefficient of the profile shape about 3.2. The profile is characterized with TA×DOC/t≈5.94, and TA/PT×BTZ≈0.745. It does also feature a sub-region of negative second derivative of CS in the compression region as a majority of the inventive examples in the present disclosure.

While the temperature of both step 1 and step 2 of this two-step example were within 110° C. of the strain point, the additional flexibility afforded by expanding to a two-step ion exchange allows to implement inventive embodiments with sub-region having negative second derivative of the CS profile even at lower temperatures without substantial activation of stress relaxation. In this approach, the negative second derivative is obtained by severely restricting the influx of Na ions in the second step when compared to the first step by using a second-step bath with much lower Na/K ratio than the first-step bath, for example where the second-step molar ratio of NaNO₃/(NaNO₃+KNO₃) is 10 times or even more than 10 times lower than that of the first bath. The design space for the ion-exchange process in that case may be reduced compared to the case of high ion-exchange temperature when it is required that the glass be non-frangible after both the first and the second step, to avoid contaminating ion-exchange equipment with glass fragments during occasional fracture of specimens during production.

An ion exchange procedure for Composition 2 that enables the inventive stress profiles of the present disclosure is now provided. The strain-point of Composition 2 is very high, at 592° C. The fracture toughness of Composition 2 is in the range 0.74-0.87 MPa m. Examples of generating inventive stress profiles using single-step high-temperature ion exchange on glass-based substrates having Composition 2 can be obtained using baths having between 8 and 20% NaNO₃, and ion-exchanging annealed-glass substrate with thickness of 0.6 mm at 490° C. (i.e., within 110° C. of the strain point) for 0.6 to 0.75 hours.

With two-step ion-exchange, inventive stress profiles with higher surface compressive stress CS than 600 MPa can be obtained, including using lower temperatures than 490° C. For example, with 0.6 mm, step 1 of ion exchange using immersion for 1 hour at 460° C. in a bath having 20% NaNO₃/80% KNO₃ by weight, followed by step 2 of 0.3 hours at 430° C. in a bath having 4% NaNO₃ and 96% KNO3 by weight.

For the case of glass of the same composition formed on a rolling platform and having somewhat higher fictive temperature, the salt baths NaNO₃ content should be increased from the range 8-20% to the range 12-25% for the 1-step process, and the ion-exchange time should be decreased by a factor of ⅔, such that at 490° C. the ion-exchange time is 0.4 to 0.5 hours. For the two-step process, the step 1 bath NaNO₃ content is increased to 25%, with the KNO₃ decreased to 75%. The step 1 ion-exchange time is decreased to 70% of that for the annealed glass, or 0.7 hours at 460° C. To maintain high surface compressive stress CS, step 2 uses 4% NaNO₃/96% KNO₃, at 430° C., for 0.2 hours.

The range of bath compositions and ion exchange temperatures for Composition 2 are very similar to Composition 1 despite the significant differences in the percentages of the different components. However, due to Composition 2 having higher diffusivity than Composition 1, the ion exchange treatment time is significantly less than that for Composition 1.

Table 3 provides the IOX treatment parameters for Examples 1-8, each of which is a chemically strengthened glass-based article produced by subjecting a glass-based substrate having Composition 1 to a chemical strengthening process in accordance with the methods described herein.

TABLE 3
IOX Treatment Parameters

| | IOX Bath | IOX | IOX |
|---|---|---|---|
| | Composition (NaNO₃/ | Temperature | Treatment |
| Example | KNO₃ by weight) | (° C.) | Time (hours) |
| 1 | 9/91 | 465 | 2.48 |
| 2 | 9/91 | 460 | 2.67 |
| 3 | 8/92 | 490 | 2.12 |
| 4 | 8/92 | 455 | 3.78 |
| 5 | 8/92 | 470 | 3.12 |
| 6 | 8/92 | 465 | 2.72 |
| 7 | 8/92 | 455 | 3.30 |
| 8 | 9/91 | 465 | 2.48 |

Table 4 provides the thickness and stress profile attributes for Examples 1-8.

TABLE 4
Stress Profile Attributes

| | Measured Properties | | | | |
|---|---|---|---|---|---|
| | | Peak | Breadth of | | |
| | Thick- | Tension, | Tension | Depth of | DOC/t |
| | ness, | PT | Zone, BTZ | Compression, | [unit- |
| Example | t [mm] | [MPa] | [mm] | DOC [mm] | less] |
| 1 | 0.499 | 128.34 | 0.2868 | 0.1061 | 0.2126 |
| 2 | 0.503 | 133.64 | 0.2894 | 0.1068 | 0.2123 |
| 3 | 0.613 | 95.784 | 0.3614 | 0.1258 | 0.2052 |
| 4 | 0.621 | 114.4 | 0.3659 | 0.1275 | 0.2053 |
| 5 | 0.613 | 110.97 | 0.3571 | 0.1279 | 0.2086 |
| 6 | 0.613 | 105.04 | 0.3746 | 0.1192 | 0.1945 |
| 7 | 0.615 | 110.7 | 0.3681 | 0.1234 | 0.2007 |
| 8 | 0.615 | 106.08 | 0.3723 | 0.1213 | 0.1972 |

| | Measured Properties | | |
|---|---|---|---|
| | Surface Compressive | Depth of Spike, | Knee Compressive |
| Example | Stress, CS [MPa] | DOL_{SP} [μm] | Stress, CSₖ [Mpa] |
| 1 | 728 | 4.39 | 205 |
| 2 | 743 | 4.38 | 210 |
| 3 | 652 | 6.2 | 132 |
| 4 | 751 | 4.32 | 215 |
| 5 | 711 | 5.5 | 178 |
| 6 | 755 | 4.37 | 174 |
| 7 | 736 | 4.42 | 210 |
| 8 | 746 | 4.4 | 231 |

| | Fitted Properties | | | | |
|---|---|---|---|---|---|
| | | | | | TA/ |
| | Peak | Tension | Power | TA*DOC/ | (PT*BTZ) |
| | Tension | Area, TA | Coeffi- | t | [unit- |
| Example | [MPa] | [MPa*mm] | cient, p | [MPa*mm] | less] |
| 1 | 128.33 | 26.053 | 2.422 | 5.540 | 0.708 |
| 2 | 133.64 | 27.627 | 2.5002 | 5.866 | 0.714 |
| 3 | 95.786 | 25.77 | 2.9115 | 5.289 | 0.744 |
| 4 | 114.4 | 31.714 | 3.1254 | 6.511 | 0.758 |
| 5 | 110.97 | 30.131 | 3.1714 | 6.287 | 0.760 |
| 6 | 105.04 | 30.822 | 3.6164 | 5.993 | 0.783 |
| 7 | 110.69 | 31.969 | 3.6421 | 6.415 | 0.785 |
| 8 | 106.08 | 31.486 | 3.9311 | 6.210 | 0.797 |

| | Fitted Properties | | | | |
|---|---|---|---|---|---|
| | Slope at | | | s*(DOC- | |
| | DOC, s | s*DOC/t | | DOL_{SP}) | Frangibility |
| | [MPa/ | [MPa/ | s*DOC | [MPa/ | Factor, Kₜ |
| Example | um] | um] | [MPa] | um] | [MPa*sqrt(m)] |
| 1 | 2.14 | 0.455 | 227.054 | 216.1 | 1.6634 |
| 2 | 2.28 | 0.484 | 243.504 | 232.1 | 1.7518 |
| 3 | 1.522 | 0.312 | 191.4676 | 180.7 | 1.4508 |
| 4 | 1.9253 | 0.3954 | 245.4758 | 235.7 | 1.7691 |
| 5 | 1.94 | 0.405 | 248.126 | 236.7 | 1.6998 |
| 6 | 1.9926 | 0.3875 | 237.5179 | 227.4 | 1.6852 |
| 7 | 2.1508 | 0.432 | 265.4087 | 254.5 | 1.7612 |
| 8 | 2.195 | 0.4332 | 266.2535 | 256.6 | 1.723 |

| | Fitted Properties | | | | |
|---|---|---|---|---|---|
| | | | PT*sqrt(t)/ | CSₖ/ | Exclusion |
| | s*t | PT*sqrt(t) | K_{IC} | (s*(DOC- | Depth |
| Example | [Mpa] | [MPa*sqrt(m)] | [unitless] | DOL_{SP})) | [mm] |
| 1 | 1068 | 2.867 | 3.221 | 0.94 | 0.067 |
| 2 | 1147 | 2.997 | 3.368 | 0.90 | 0.067 |
| 3 | 933 | 2.372 | 2.665 | 0.73 | 0.088 |
| 4 | 1196 | 2.851 | 3.203 | 0.91 | 0.09 |
| 5 | 1189 | 2.747 | 3.087 | 0.75 | 0.091 |
| 6 | 1221 | 2.601 | 2.922 | 0.76 | 0.091 |
| 7 | 1323 | 2.745 | 3.084 | 0.82 | 0.098 |
| 8 | 1350 | 2.631 | 2.956 | 0.90 | 0.09 |

The stress profile attributes for the chemically strengthened glass-based articles of Examples 1-8 provided above in Table 4 demonstrate a uniform tensile stress distribution in the central tension zone that allows for an increase in the amount of compressive stress in the compressive stress layers, while also avoiding frangibility. To illustrate the differences between the inventive stress profiles of the present disclosure and the stress profiles not employing the present teachings, i.e., strengthened glass articles found in the prior art, the averaged retardance curve, power model fitting, residuals for the power model, and the stress profile corresponding to the fitted power model are shown for a comparative example in FIGS. 8, 10, 12, and 14, respectively. By comparing the stress profile of inventive Example 7, shown in FIG. 13, with the stress profile of the comparative example, shown in FIG. 14, the increased tension area provided by the uniform tensile stress distribution of the Example 7 can be observed. Moreover, as described above, a uniform tensile stress distribution is desired because the tensile-strain energy (TSE) is proportional to the depth integral over the central tension zone of the squared tensile stress, whereas the tension area TA (which by force-balance equals the compressive-stress area) is the depth integral over the central tension zone of the tensile stress only (i.e., not squared). Hence, a less uniform stress distribution results in an increase in the TSE for a fixed TA. Since frangibility imposes an upper limit on the TSE, the increased TA of the embodiments described herein allow for increased levels of compressive stress in the compress stress layers while maintaining non-frangibility for the chemically strengthened glass-based articles.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A chemically strengthened glass-based article comprising:
a first major surface and an opposing second major surface defining a thickness t of the glass-based article;
a stress profile σ(x) wherein x extends through the thickness t of the glass-based article in a direction normal to the first major surface and the second major surface;
a first compressive stress layer extending from the first major surface to a first depth of compression DOC₁ greater than about 0.15 t;
a second compressive stress layer extending from the second major surface to a second depth of compression DOC₂ less than or equal to DOC₁; and
a central tension zone positioned between the first and second compressive stress layers and comprising a peak tension PT and a breadth of tension zone BTZ spanning DOC₁ to t-DOC₂,
wherein:
$$\frac{DOC}{t} {S}_{σ}^{DOC} > 0.2 MPa / μ m ,$$
where DOC=DOC₁ and s_{σ}^{DOC} is the slope of the stress profile σ(x) at DOC;
$$DOC \times {s}_{σ}^{DOC} > 140 MPa ; and$$
$$\frac{TA}{PT \times BTZ} > 0.735 ,$$
where TA is the tension area, defined by:
$$TA = {\int }_{{DOC}_{1}}^{t - {DOC}_{2}} σ ( x ) dx .$$

2. The chemically strengthened glass-based article of claim 1, wherein the peak tension PT is greater than 90 MPa.

3. The chemically strengthened glass-based article of claim 1, wherein:
$$PT > 2.6 \frac{{K}_{IC}}{\sqrt{t}} ,$$
where K_{IC} is a fracture toughness of the glass-based article in a position xₚₑₐₖ in the central tension zone corresponding with the peak tension PT.

4. The chemically strengthened glass-based article of claim 1, wherein the thickness t of the glass-based article is between 0.43 mm and 0.68 mm.

5. The chemically strengthened glass-based article of claim 1, wherein:
a composition of the glass-based article comprises Li₂O in an amount in the range from about 7.5 mol % to about 11 mol %; and
a fracture toughness K_{IC} of the glass-based article is greater than or equal to 0.850 MPa\sqrt{m} in a position xₚₑₐₖ in the central tension zone corresponding with the peak tension PT.

6. The chemically strengthened glass-based article of claim 1, wherein the stress profile σ(x) in the central tension zone, when fit to Equation I,
$$σ ( x ) = PT [ 1 - {\vert \frac{{x}_{peak} - x}{{x}_{peak} - DOC} \vert}^{p} ] , \qquad ( Equation I )$$
has a best-fit value of power coefficient p that exceeds 2.4 but does not exceed 20, wherein xₚₑₐₖ is a position in the central tension zone corresponding with the peak tension PT.

7. The chemically strengthened glass-based article of claim 1, further comprising a frangibility factor Kₜ not exceeding 2.1×K_{IC}, wherein K_{IC} is a fracture toughness of the glass-based article in a position xₚₑₐₖ in the central tension zone corresponding with the peak tension PT, and wherein:
$${K}_{t} = \sqrt{{\int }_{{DOC}_{1}}^{t - {DOC}_{2}} {σ}^{2} dx} ,$$
where σ is the stress profile σ(x).

8. The chemically strengthened glass-based article of claim 1, wherein DOC is greater than or equal to 0.190 t.

9. The chemically strengthened glass-based article of claim 1, wherein the stress profile σ(x) exhibits a spike at the first and second major surfaces and a knee stress CSₖ at a depth of spike DOL_{SP} satisfies Relation II:
$$100 MPa \leq {CS}_{k} \leq 1.1 ( DOC - {DOL}_{sp} ) \times {s}_{σ}^{DOC} . \qquad ( Relation II )$$

10. The chemically strengthened glass-based article of claim 9, wherein:
$$0 \leq {DOL}_{sp} \leq {DOL}_{ul} ,$$
where DOLᵤₗ is the larger of 4 μm and 0.01 t.

11. The chemically strengthened glass-based article of claim 1, wherein the stress profile σ(x) exhibits a spike at the first and second major surfaces and a knee stress CSₖ at a depth of spike DOL_{SP}, and wherein a portion of the stress profile σ(x) between DOL_{SP} and DOC comprises a negative second derivative.

12. The chemically strengthened glass-based article of claim 1, wherein:
$$DOC \times {s}_{σ}^{DOC} > 190 MPa .$$

13. The chemically strengthened glass-based article of claim 1, wherein:
$$\frac{DOC}{t} {s}_{σ}^{DOC} > 0.3 MPA / μm .$$

14. The chemically strengthened glass-based article of claim 1, wherein:
$$t \times {s}_{σ}^{DOC} > 900 MPA .$$

15. The chemically strengthened glass-based article of claim 1, wherein a surface compressive stress CS is greater than or equal to 550 MPa.

16. The chemically strengthened glass-based article of claim 1, wherein the chemically strengthened glass-based article is a glass-ceramic material comprising an amorphous phase and a crystalline phase.

17. The chemically strengthened glass-based article of claim 1, wherein the chemically strengthened glass-based article is formed by subjecting a glass-based substrate to an ion exchange treatment, and wherein the glass-based substrate comprises:
greater than or equal to 50 mol % and less than or equal to 75 mol % SiO₂;
greater than or equal to 10 mol % and less than or equal to 25 mol % Al₂O₃;
greater than or equal to 1 mol % and less than or equal to 11 mol % B₂O₃;
greater than or equal to 1 mol % and less than or equal to 10 mol % Na₂O; and
greater than or equal to 5 mol % and less than or equal to 15 mol % Li₂O, wherein a molar concentration of Li₂O in the glass-based substrate is greater than a molar concentration of Na₂O in the glass-based substrate.

18. The chemically strengthened glass-based article of claim 1, wherein the chemically strengthened glass-based article is formed by subjecting a glass-based substrate to an ion exchange treatment, and wherein the glass-based substrate comprises a molar ratio of Li₂O to Na₂O of greater than or equal to 2.0.

19. A chemically strengthened glass-based article comprising:
a first major surface and an opposing second major surface defining a thickness t of the glass-based article, wherein the thickness t is from about 0.43 mm to about 0.68 mm;
a stress profile σ(x) wherein x extends through the thickness t of the glass-based article in a direction normal to the first major surface and the second major surface;
a first compressive stress layer extending from the first major surface to a first depth of compression DOC₁ greater than about 0.19 t;
a second compressive stress layer extending from the second major surface to a second depth of compression DOC₂ less than or equal to DOC₁; and
a central tension zone positioned between the first and second compressive stress layers and comprising a peak tension PT and a breadth of tension zone BTZ spanning DOC₁ to t-DOC₂,
wherein:
the peak tension PT is greater than 95 MPa;
the stress profile σ(x) in the central tension zone, when fit to Equation I,
$$σ ( x ) = PT [ 1 - {\vert \frac{{x}_{peak} - x}{{x}_{peak} - DOC} \vert}^{p} ] , \qquad ( Equation I )$$
has a best-fit value of power coefficient p that exceeds 2.4, where DOC=DOC₁ and xₚₑₐₖ is a position in the central tension zone corresponding with the peak tension PT; and
the stress profile σ(x) exhibits a spike at the first and second major surfaces and a knee stress CSₖ at a depth of spike DOL_{SP} satisfies Relation II:
$$100 MPa \leq {CS}_{k} \leq 1.1 ( DOC - {DOL}_{sp} ) \times {s}_{σ}^{DOC} \qquad ( Relation II )$$
where DOC=DOC₁ and s_{σ}^{DOC} is the slope of the stress profile σ(x) at DOC.

20. A method of manufacturing a chemically strengthened glass-based article, the method comprising exposing a glass-based substrate to a molten salt bath to form the chemically strengthened glass-based article, wherein:
the temperature of the molten salt bath is less than a strain point of the glass-based substrate by no more than 110° C., wherein the strain point of the glass-based substrate is determined by fiber elongation;
the chemically strengthened glass-based article comprises a first major surface and an opposing second major surface defining a thickness t of the glass-based article; and
the ion exchange treatment time is selected such that the chemically strengthened glass-based article comprises:
a stress profile σ(x) wherein x extends through the thickness t of the glass-based article in a direction normal to the first major surface and the second major surface;
a first compressive stress layer extending from the first major surface to a first depth of compression DOC₁ greater than about 0.15 t;
a second compressive stress layer extending from the second major surface to a second depth of compression DOC₂ less than or equal to DOC₁; and
a central tension zone positioned between the first and second compressive stress layers and comprising a peak tension PT and a breadth of tension zone BTZ spanning DOC₁ to t-DOC₂,
wherein:
$$\frac{DOC}{t} {s}_{σ}^{DOC} > 0.2 MPA / μm ,$$
where DOC=DOC₁ and s_{σ}^{DOC} is the slope of the stress profile σ(x) at DOC;
$$DOC \times {s}_{σ}^{DOC} > 140 MPa ; and$$
$$\frac{TA}{PT \times BTZ} > 0.735 ,$$
where TA is the tension area, defined by:
$$TA = {\int }_{{DOC}_{1}}^{t - {DOC}_{2}} σ ( x ) dx .$$
